(19) United States
(12) Patent Application Publication
(10) Pub. No.: US 2025/0211847 A1
(43) Pub. Date: Jun. 26, 2025

(54) MANAGEMENT APPARATUS, IMAGING SYSTEM, MANAGEMENT METHOD, AND MANAGEMENT PROGRAM

(71) Applicant: FUJIFILM Corporation, Tokyo (JP)

(72) Inventors: Masahiko SUGIMOTO, Saitama-shi (JP); Tetsuya FUJIKAWA, Saitama-shi (JP); Tomoharu SHIMADA, Saitama-shi (JP)

(73) Assignee: FUJIFILM Corporation, Tokyo (JP)

(21) Appl. No.: 19/080,924

(22) Filed: Mar. 16, 2025

Related U.S. Application Data
(63) Continuation of application No. PCT/JP2023/029093, filed on Aug. 9, 2023.

(30) Foreign Application Priority Data
Sep. 26, 2022 (JP) 2022-153055

(51) Int. Cl. H04N 23/61; G06F 3/14; G06T 5/50

(52) U.S. Cl. CPC H04N 23/61; G06F 3/14; G06T 5/50; G06T 2207/20221

(57) ABSTRACT

A management apparatus is communicable with a first imaging apparatus that images a subject and a second imaging apparatus that is in a region which the first imaging apparatus is capable of imaging, and includes a processor which is configured to acquire attribute information of the second imaging apparatus based on at least one of: a result of image processing on first imaging data acquired by the first imaging apparatus; or information related to imaging of the first imaging apparatus.

### CROSS REFERENCE TO RELATED APPLICATION

This is a continuation of International Application No. PCT/JP2023/029093 filed on Aug. 9, 2023, and claims priority from Japanese Patent Application No. 2022-153055 filed on Sep. 26, 2022, the entire disclosures of which are incorporated herein by reference.

### BACKGROUND OF THE INVENTION

### 1. Field of the Invention

The present invention relates to a management apparatus, an imaging system, a management method, and a computer readable medium storing a management program.

### 2. Description of the Related Art

JP2019-121055A discloses an information processing system in which, in a case where a confirmation request for a designated field is received from a field image captured by a fixed point camera, the confirmation request is transmitted from an information processing terminal to a mobile terminal together with a camera identification (ID) of the fixed point camera of the designated field, and in a case where the transmitted camera ID matches a camera ID of the fixed point camera separately held by the mobile terminal, a detailed image of the designated field is captured by the mobile terminal, and the acquired image data is transmitted to a server device.

JP2018-164220A discloses a work support system in which an entire region captured image captured by an imaging apparatus is displayed on a mobile terminal of a user, and in a case where any position on the entire region captured image displayed on the mobile terminal is instructed, an image at the instructed position is displayed on the mobile terminal.

JP2004-032608A discloses an image storage management system that checks a location of a camera from position information of the camera, transmits imaging instruction information to the camera to perform imaging, and transmits acquired image data to an image management apparatus via a network.

JP2001-344285A discloses a damage information collection management apparatus in which image data captured by a mobile information terminal is transmitted to a disaster information center with position information of an imaging location attached, a distance between a position of a representative point of each damage area and the imaging location of the image data is determined by a determination unit of the disaster information center, and the image data is stored in a damage information accumulation unit in association with a damage area having a minimum determined distance.

### SUMMARY OF THE INVENTION

One embodiment according to the technique of the present disclosure provides a management apparatus, an imaging system, a management method, and a computer readable medium storing a management program capable of mutually utilizing captured images obtained by a plurality of imaging apparatuses at different distances to a subject.

(1)

A management apparatus that is communicable with a first imaging apparatus that images a subject and a second imaging apparatus that is in a region which the first imaging apparatus is capable of imaging, the management apparatus comprising:

a processor, in which

the processor is configured to acquire attribute information of the second imaging apparatus based on at least one of a result of image processing on first imaging data acquired by the first imaging apparatus or information related to imaging of the first imaging apparatus.

(2)

The management apparatus according to (1), in which

the processor is configured to transmit, to the second imaging apparatus, imaging instruction information indicating an imaging condition of the subject, based on the attribute information.

(3)

The management apparatus according to (2), in which

the imaging condition is designated by a user of the management apparatus.

(4)

The management apparatus according to (2), in which

the imaging condition is a condition for supplementing a shortage of the first imaging data.

(5)

The management apparatus according to (4), in which

the imaging condition is indicated by a fixed tool.

(6)

The management apparatus according to any one of (2) to (5), in which

the processor is configured to cause a display device to output at least one of a first captured image represented by the first imaging data or a second captured image represented by second imaging data acquired by the second imaging apparatus, and receive designation of the imaging condition from a user.

(7)

The management apparatus according to any one of (1) to (6), in which

the information related to the imaging is a range set based on an imaging direction of the first imaging apparatus.

(8)

The management apparatus according to (7), in which

the range is set based on an angle of view of the first imaging apparatus.

(9)

The management apparatus according to (7) or (8), in which

the range is set based on position information associated with the imaging direction.

(10)

The management apparatus according to any one of (7) to (9), in which

the processor is configured to acquire the attribute information based on the range and GPS information of a plurality of imaging apparatuses including the second imaging apparatus.

(11)

The management apparatus according to any one of (1) to (10), in which

the processor is configured to acquire the attribute information of the second imaging apparatus based on a recognition result of a possessor of the second imaging apparatus or an installation target of the second imaging apparatus by the image processing.

(12)

A management apparatus that is communicable with a first imaging apparatus that images a subject and a second imaging apparatus that is at a different location from the first imaging apparatus, the management apparatus comprising:

a processor, in which

the processor is configured to:
cause the first imaging apparatus to perform imaging based on at least one of position information of the second imaging apparatus or an imaging condition designated from the second imaging apparatus; and
transmit first imaging data acquired by the first imaging apparatus to the second imaging apparatus.
   (13)

The management apparatus according to (12), in which

the processor is configured to cause a display device to output at least one of a first captured image represented by the first imaging data acquired by the first imaging apparatus or a second captured image represented by second imaging data acquired by the second imaging apparatus.

(14)

The management apparatus according to any one of (1) to (13), in which

the management apparatus is communicable with a revolution apparatus that causes the first imaging apparatus to revolve, and

the processor is configured to acquire correspondence information between a control value of the revolution apparatus and a position of the imaging target by the first imaging apparatus.

(15)

The management apparatus according to (14), in which

the processor is configured to:
generate first composite image data by combining a plurality of pieces of image data acquired by the first imaging apparatus while changing an imaging direction of the first imaging apparatus by controlling the revolution apparatus; and
generate correspondence information between coordinates of a first composite image represented by the first composite image data and the control value of the revolution apparatus.
   (16)

An imaging system comprising:

a first imaging apparatus that images a subject;

a second imaging apparatus that is in a region which the first imaging apparatus is capable of imaging; and

a management apparatus that is communicable with the first imaging apparatus and the second imaging apparatus, in which

a processor of the management apparatus is configured to acquire attribute information of the second imaging apparatus based on at least one of a result of image processing on first imaging data acquired by the first imaging apparatus or information related to imaging of the first imaging apparatus.

(17)

An imaging system comprising:

a first imaging apparatus that images a subject;

a second imaging apparatus that is at a different location from the first imaging apparatus; and

a management apparatus that is communicable with the first imaging apparatus and the second imaging apparatus, in which

a processor of the management apparatus is configured to:
cause the first imaging apparatus to perform imaging based on at least one of position information of the second imaging apparatus or an imaging condition designated from the second imaging apparatus; and
transmit first imaging data acquired by the first imaging apparatus to the second imaging apparatus.
   (18)

A management method by a management apparatus that is communicable with a first imaging apparatus that images a subject and a second imaging apparatus that is in a region which the first imaging apparatus is capable of imaging, the method comprising:

via a processor of the management apparatus,

acquiring attribute information of the second imaging apparatus based on at least one of a result of image processing on first imaging data acquired by the first imaging apparatus or information related to imaging of the first imaging apparatus.

(19)

A management method by a management apparatus that is communicable with a first imaging apparatus that images a subject and a second imaging apparatus that is at a different location from the first imaging apparatus, the method comprising:

via a processor of the management apparatus,

causing the first imaging apparatus to perform imaging based on at least one of position information of the second imaging apparatus or an imaging condition designated from the second imaging apparatus; and

transmitting first imaging data acquired by the first imaging apparatus to the second imaging apparatus.

(20)

A computer readable medium storing a management program of a management apparatus that is communicable with a first imaging apparatus that images a subject and a second imaging apparatus that is in a region which the first imaging apparatus is capable of imaging, the program causing a processor of the management apparatus to execute a process comprising:

acquiring attribute information of the second imaging apparatus based on at least one of a result of image processing on first imaging data acquired by the first imaging apparatus or information related to imaging of the first imaging apparatus.

(21)

A computer readable medium storing a management program of a management apparatus that is communicable with a first imaging apparatus that images a subject and a second imaging apparatus that is at a different location from the first imaging apparatus, the program causing a processor of the management apparatus to execute a process comprising:

causing the first imaging apparatus to perform imaging based on at least one of position information of the second imaging apparatus or an imaging condition designated from the second imaging apparatus; and

transmitting first imaging data acquired by the first imaging apparatus to the second imaging apparatus.

According to the aspects of the present invention, it is possible to provide a management apparatus, an imaging system, a management method, and a computer readable medium storing a management program capable of mutually utilizing captured images obtained by a plurality of imaging apparatuses at different distances to a subject.

### BRIEF DESCRIPTION OF THE DRAWINGS

FIG. 1 is a diagram showing an example of an imaging system 1 equipped with a management apparatus 11 of the present embodiment.

FIG. 2 is a diagram showing an example of revolution of a surveillance camera 10 in a pitch direction by a revolution mechanism 16.

FIG. 3 is a diagram showing an example of the revolution of the surveillance camera 10 in a yaw direction by the revolution mechanism 16.

FIG. 4 is a block diagram showing an example of a configuration of an optical system and an electrical system of the surveillance camera 10.

FIG. 5 is a diagram showing an example of a configuration of an electrical system of the revolution mechanism 16 and a management apparatus 11.

FIG. 6 is a diagram showing an example of a hardware configuration of a terminal device possessed by a worker in a surveillance target region.

FIG. 7 is a diagram showing an example of an image displayed by the management apparatus 11.

FIG. 8 is a flowchart showing an example of a first form of processing by the management apparatus 11.

FIG. 9 is a sequence diagram showing an example of the first form of processing by the imaging system 1.

FIG. 10 is a diagram showing an example of a captured image transmitted from a terminal device 100.

FIG. 11 is a diagram showing an example of a captured image transmitted from the terminal device 100.

FIG. 12 is a diagram showing Modification Example 1 of the imaging system 1.

FIG. 13 is a diagram showing an example of a configuration of the electrical system of the management apparatus 11 shown in FIG. 12.

FIG. 14 is a diagram showing an example of an image displayed by the management apparatus 11 in configurations shown in FIGS. 12 and 13.

FIG. 15 is a diagram showing Modification Example 2 of the imaging system 1.

FIG. 16 is a diagram showing an example of a configuration of the electrical system of the management apparatus 11 shown in FIG. 15.

FIG. 17 is a diagram showing an example of a checking processing of a person in poor physical condition, an injured person, or the like.

FIG. 18 is a flowchart showing an example of a second form of processing by the management apparatus 11.

FIG. 19 is a sequence diagram showing an example of the second form of processing by the imaging system 1.

FIG. 20 is a sequence diagram showing another example in the second form of the processing by the imaging system 1.

FIG. 21 is a diagram showing an example of an aspect in which a management program for management control is installed in the control device 60 of the management apparatus 11 from a storage medium in which the management program is stored.

### DESCRIPTION OF THE PREFERRED EMBODIMENTS

Hereinafter, an example of an embodiment of the present invention will be described with reference to the drawings.

### <Imaging System of Embodiment>

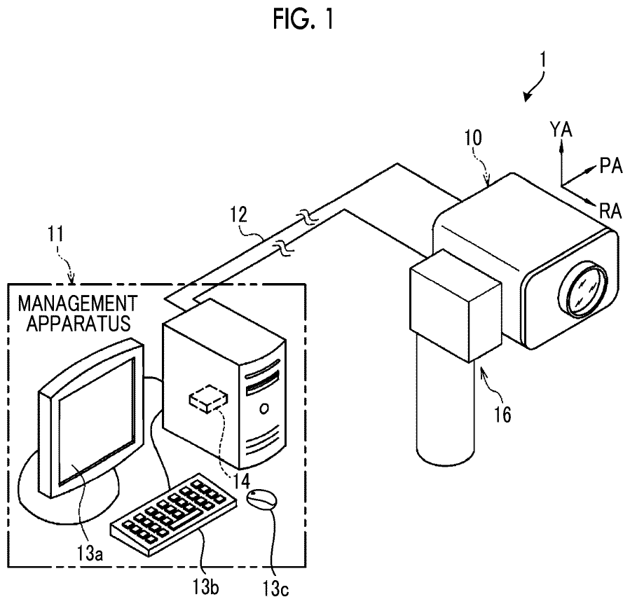

FIG. 1 is a diagram showing an example of an imaging system 1 equipped with a management apparatus of the present embodiment. As shown in FIG. 1 as an example, the imaging system 1 includes a surveillance camera 10, a management apparatus 11, and a revolution mechanism 16. The surveillance camera 10 is an example of a first imaging apparatus according to the embodiment of the present invention.

The surveillance camera 10 is a camera for performing surveillance of a facility that is the basis of life or industrial activity. The surveillance camera 10 performs surveillance of, for example, a construction site, a river, a bridge, and the like. A camera capable of telephoto imaging, a camera having ultra-high resolution, and the like are used as the surveillance camera 10. In addition, a wide-angle camera may be used as the surveillance camera 10. The surveillance camera 10 is installed in an indoor or outdoor post or wall, a part (for example, rooftop) of a building, or the like, via the revolution mechanism 16, to capture an imaging target that is a subject. The surveillance camera 10 transmits, to the management apparatus 11 via a communication line 12, a captured image obtained by the capturing and imaging information related to the capturing of the captured image.

The management apparatus 11 comprises a display 13a, a keyboard 13b, a mouse 13c, and a secondary storage device 14. Examples of the display 13a include a liquid crystal display, a plasma display, an organic electro-luminescence (EL) display, and a cathode ray tube (CRT) display. The display 13a is an example of a display device according to the embodiment of the present invention.

An example of the secondary storage device 14 includes a hard disk drive (HDD). The secondary storage device 14 is not limited to the HDD, and may be a non-volatile memory such as a flash memory, a solid state drive (SSD), or an electrically erasable and programmable read only memory (EEPROM).

The management apparatus 11 receives the captured image or the imaging information, which is transmitted from the surveillance camera 10, and displays the received captured image or imaging information on the display 13a or stores the received captured image or imaging information in the secondary storage device 14.

The management apparatus 11 performs imaging control of controlling the imaging performed by the surveillance camera 10. For example, the management apparatus 11 communicates with the surveillance camera 10 via the communication line 12 to perform the imaging control. The imaging control is to set, to the surveillance camera 10, an imaging parameter for the imaging performed by the surveillance camera 10 and to cause the surveillance camera 10 to execute the imaging. The imaging parameters include a parameter related to exposure, a parameter of a zoom position, and the like.

In addition, the management apparatus 11 controls the revolution mechanism 16 to perform control of the imaging direction (pan and tilt) of the surveillance camera 10. For example, the management apparatus 11 sets the revolution direction, the revolution amount, the revolution speed, and the like of the surveillance camera 10 in response to an operation of the keyboard 13b and the mouse 13c, or a touch operation of the display 13a on the screen.

### <Revolution of Surveillance Camera 10 by Revolution Mechanism 16>

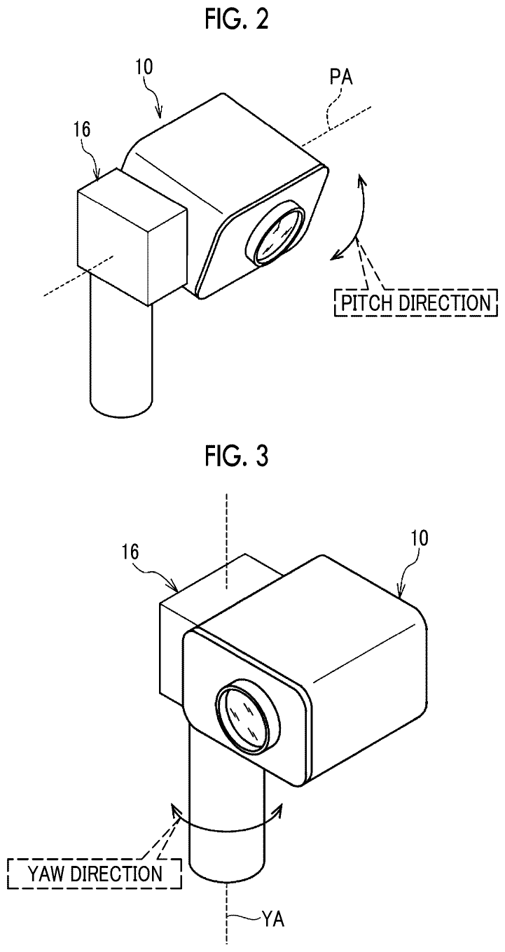

FIG. 2 is a diagram showing an example of revolution of the surveillance camera 10 in a pitch direction by the revolution mechanism 16. FIG. 3 is a diagram showing an example of the revolution of the surveillance camera 10 in a yaw direction by the revolution mechanism 16. The surveillance camera 10 is attached to the revolution mechanism 16. The revolution mechanism 16 can change the imaging direction of the surveillance camera 10 by revolving the surveillance camera 10.

Specifically, the revolution mechanism 16 is a two-axis revolution mechanism that enables the surveillance camera 10 to revolve in a revolution direction (pitch direction) that intersects the yaw direction and that has a pitch axis PA as a central axis, as shown in FIG. 2 as an example, and in a revolution direction (yaw direction) that has a yaw axis YA as a central axis, as shown in FIG. 3 as an example. An example is shown in which the two-axis revolution mechanism is used as the revolution mechanism 16 according to the present embodiment, but the technique of the present disclosure is not limited thereto. A three-axis revolution mechanism or a one-axis revolution mechanism may be used.

### <Configuration of Optical System and Electrical System of Surveillance Camera 10>

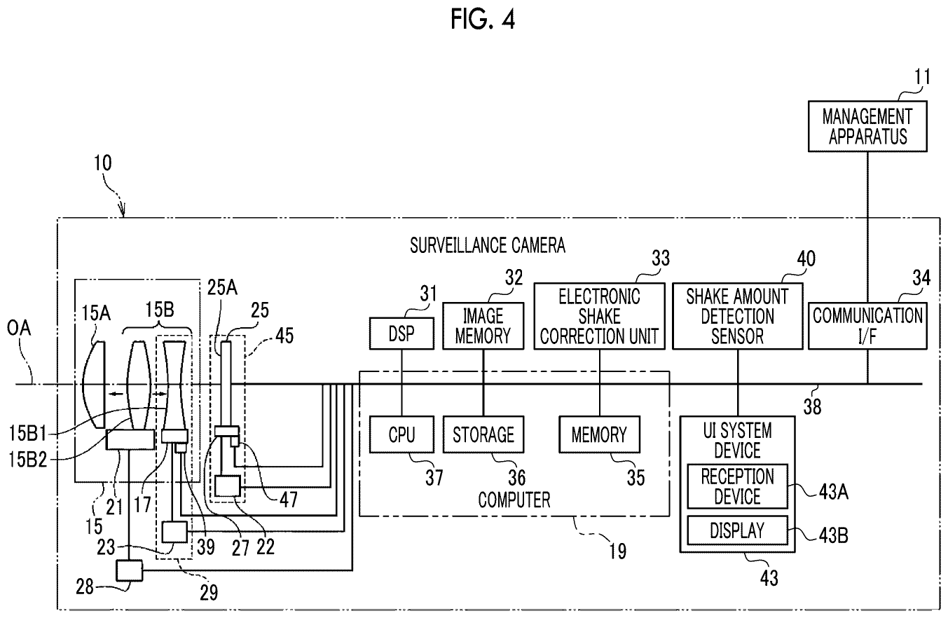

FIG. 4 is a block diagram showing an example of a configuration of an optical system and an electrical system of the surveillance camera 10. As shown in FIG. 4 as an example, the surveillance camera 10 comprises an optical system 15 and an imaging element 25. The imaging element 25 is located after the optical system 15. The optical system 15 comprises an objective lens 15A and a lens group 15B. The objective lens 15A and the lens group 15B are disposed, along an optical axis OA of the optical system 15, over a light-receiving surface 25A side (image side) of the imaging element 25 from a target subject side (object side) in an order of the objective lens 15A and the lens group 15B. The lens group 15B includes an anti-vibration lens 15B1, a focus lens (not illustrated), a zoom lens 15B2, and the like. The zoom lens 15B2 is movably supported along the optical axis OA by a lens actuator 21 described below. The anti-vibration lens 15B1 is movably supported in a direction orthogonal to the optical axis OA by a lens actuator 17 described below.

An increase in a focal length by the zoom lens 15B2 sets the surveillance camera 10 on a telephoto side, and thus an angle of view is decreased (imaging range is narrowed). A decrease in the focal length by the zoom lens 15B2 sets the surveillance camera 10 on a wide angle side, and thus the angle of view is increased (imaging range is widened).

Various lenses (not illustrated) may be provided as the optical system 15 in addition to the objective lens 15A and the lens group 15B. Furthermore, the optical system 15 may comprise a stop. Positions of the lenses, the lens group, and the stop included in the optical system 15 are not limited. For example, the technique of the present disclosure is also effective for positions different from the positions shown in FIG. 4.

The anti-vibration lens 15B1 is movable in a direction perpendicular to the optical axis OA, and the zoom lens 15B2 is movable along the optical axis OA.

The optical system 15 comprises the lens actuators 17 and 21. The lens actuator 17 causes force that fluctuates in a direction perpendicular to an optical axis of the anti-vibration lens 15B1 to act on the anti-vibration lens 15B1. The lens actuator 17 is controlled by an optical image stabilizer (OIS) driver 23. With the drive of the lens actuator 17 under the control of the OIS driver 23, the position of the anti-vibration lens 15B1 fluctuates in the direction perpendicular to the optical axis OA.

The lens actuator 21 causes force that moves along the optical axis OA of the optical system 15 to act on the zoom lens 15B2. The lens actuator 21 is controlled by a lens driver 28. With the drive of the lens actuator 21 under the control of the lens driver 28, the position of the zoom lens 15B2 moves along the optical axis OA. With the movement of the position of the zoom lens 15B2 along the optical axis OA, the focal length of the surveillance camera 10 changes.

For example, in a case where a contour of the captured image is a rectangle having a short side in the direction of the pitch axis PA and having a long side in the direction of the yaw axis YA, the angle of view in the direction of the pitch axis PA is narrower than the angle of view in the direction of the yaw axis YA and the angle of view of a diagonal line.

With the optical system 15 configured in such a manner, light indicating an imaging target forms an image on the light-receiving surface 25A of the imaging element 25, and the imaging target is imaged by the imaging element 25.

By the way, a vibration provided to the surveillance camera 10 includes, in an outdoor situation, a vibration caused by passage of automobiles, a vibration caused by wind, a vibration caused by a road construction, and the like, and includes, in an indoor situation, a vibration caused by an air conditioner operation, a vibration caused by comings and goings of people, and the like. Thus, in the surveillance camera 10, a shake occurs due to the vibration provided to the surveillance camera 10 (hereinafter also simply referred to as “vibration”).

In the present embodiment, the term “shake” refers to a phenomenon, in the surveillance camera 10, in which a target subject image on the light-receiving surface 25A of the imaging element 25 fluctuates due to a change in positional relationship between the optical axis OA and the light-receiving surface 25A. In other words, it can be said that the term “shake” is a phenomenon in which an optical image, which is obtained by the image forming on the light-receiving surface 25A, fluctuates due to a tilt of the optical axis OA caused by the vibration provided to the surveillance camera 10. The fluctuation of the optical axis OA means that the optical axis OA is tilted with respect to, for example, a reference axis (for example, the optical axis OA before the shake occurs). Hereinafter, the shake that occurs due to the vibration will be simply referred to as “shake”.

The shake is included in the captured image as a noise component and affects image quality of the captured image. In order to remove the noise component included in the captured image due to the shake, the surveillance camera 10 comprises a lens-side shake correction mechanism 29, an imaging element-side shake correction mechanism 45, and an electronic shake correction unit 33, which are used for shake correction.

The lens-side shake correction mechanism 29 and the imaging element-side shake correction mechanism 45 are mechanical shake correction mechanisms. The mechanical shake correction mechanism is a mechanism that corrects the shake by applying, to a shake correction element (for example, anti-vibration lens 15B1 and/or imaging element 25), power generated by a driving source such as a motor (for example, voice coil motor) to move the shake correction element in a direction perpendicular to an optical axis of an imaging optical system.

Specifically, the lens-side shake correction mechanism 29 is a mechanism that corrects the shake by applying, to the anti-vibration lens 15B1, the power generated by the driving source such as the motor (for example, voice coil motor) to move the anti-vibration lens 15B1 in the direction perpendicular to the optical axis of the imaging optical system. The imaging element-side shake correction mechanism 45 is a mechanism that corrects the shake by applying, to the imaging element 25, the power generated by the driving source such as the motor (for example, voice coil motor) to move the imaging element 25 in the direction perpendicular to the optical axis of the imaging optical system. The electronic shake correction unit 33 performs image processing on the captured image based on a shake amount to correct the shake. That is, the shake correction unit (shake correction component) mechanically or electronically corrects the shake using a hardware configuration and/or a software configuration. The mechanical shake correction refers to the shake correction implemented by mechanically moving the shake correction element, such as the anti-vibration lens 15B1 and/or the imaging element 25, using the power generated by the driving source such as the motor (for example, voice coil motor). The electronic shake correction refers to the shake correction implemented by performing, for example, the image processing by a processor.

As shown in FIG. 4 as an example, the lens-side shake correction mechanism 29 comprises the anti-vibration lens 15B1, the lens actuator 17, the OIS driver 23, and a position sensor 39.

As a method of correcting the shake by the lens-side shake correction mechanism 29, various well-known methods can be employed. In the present embodiment, as the method of correcting the shake, a shake correction method is employed in which the anti-vibration lens 15B1 is caused to move based on the shake amount detected by a shake amount detection sensor 40 (described below). Specifically, the anti-vibration lens 15B1 is caused to move, by an amount with which the shake cancels, in a direction of canceling the shake to correct the shake.

The lens actuator 17 is attached to the anti-vibration lens 15B1. The lens actuator 17 is a shift mechanism equipped with the voice coil motor and drives the voice coil motor to cause the anti-vibration lens 15B1 to fluctuate in the direction perpendicular to the optical axis of the anti-vibration lens 15B1. Here, as the lens actuator 17, the shift mechanism equipped with the voice coil motor is employed, but the technique of the present disclosure is not limited thereto. Instead of the voice coil motor, another power source such as a stepping motor or a piezo element may be employed.

The lens actuator 17 is controlled by the OIS driver 23. With the drive of the lens actuator 17 under the control of the OIS driver 23, the position of the anti-vibration lens 15B1 mechanically fluctuates in a two-dimensional plane perpendicular to the optical axis OA.

The position sensor 39 detects a current position of the anti-vibration lens 15B1 and outputs a position signal indicating the detected current position. Here, as an example of the position sensor 39, a device including a Hall element is employed. Here, the current position of the anti-vibration lens 15B1 refers to a current position in an anti-vibration lens two-dimensional plane. The anti-vibration lens two-dimensional plane refers to a two-dimensional plane perpendicular to the optical axis of the anti-vibration lens 15B1. In the present embodiment, the device including the Hall element is employed as an example of the position sensor 39, but the technique of the present disclosure is not limited thereto. Instead of the Hall element, a magnetic sensor, a photo sensor, or the like may be employed.

The lens-side shake correction mechanism 29 causes the anti-vibration lens 15B1 to move along at least one of the direction of the pitch axis PA or the direction of the yaw axis YA in an actually imaged range to correct the shake. That is, the lens-side shake correction mechanism 29 causes the anti-vibration lens 15B1 to move in the anti-vibration lens two-dimensional plane by a movement amount corresponding to the shake amount to correct the shake.

The imaging element-side shake correction mechanism 45 comprises the imaging element 25, a body image stabilizer (BIS) driver 22, an imaging element actuator 27, and a position sensor 47.

In the same manner as the method of correcting the shake by the lens-side shake correction mechanism 29, various well-known methods can be employed as the method of correcting the shake by the imaging element-side shake correction mechanism 45. In the present embodiment, as the method of correcting the shake, a shake correction method is employed in which the imaging element 25 is caused to move based on the shake amount detected by the shake amount detection sensor 40. Specifically, the imaging element 25 is caused to move, by an amount with which the shake cancels, in a direction of canceling the shake to correct the shake.

The imaging element actuator 27 is attached to the imaging element 25. The imaging element actuator 27 is a shift mechanism equipped with the voice coil motor and drives the voice coil motor to cause the imaging element 25 to fluctuate in the direction perpendicular to the optical axis of the anti-vibration lens 15B1. Here, as the imaging element actuator 27, the shift mechanism equipped with the voice coil motor is employed, but the technique of the present disclosure is not limited thereto. Instead of the voice coil motor, another power source such as a stepping motor or a piezo element may be employed.

The imaging element actuator 27 is controlled by the BIS driver 22. With the drive of the imaging element actuator 27 under the control of the BIS driver 22, the position of the imaging element 25 mechanically fluctuates in the direction perpendicular to the optical axis OA. The position sensor 47 detects a current position of the imaging element 25 and outputs a position signal indicating the detected current position. Here, as an example of the position sensor 47, a device including a Hall element is employed. Here, the current position of the imaging element 25 refers to a current position in an imaging element two-dimensional plane. The imaging element two-dimensional plane refers to a two-dimensional plane perpendicular to the optical axis of the anti-vibration lens 15B1. In the present embodiment, the device including the Hall element is employed as an example of the position sensor 47, but the technique of the present disclosure is not limited thereto. Instead of the Hall element, a magnetic sensor, a photo sensor, or the like may be employed.

The surveillance camera 10 comprises a computer 19, a digital signal processor (DSP) 31, an image memory 32, the electronic shake correction unit 33, a communication I/F 34, the shake amount detection sensor 40, and a user interface (UI) system device 43. The computer 19 comprises a memory 35, a storage 36, and a central processing unit (CPU) 37.

The imaging element 25, the DSP 31, the image memory 32, the electronic shake correction unit 33, the communication I/F 34, the memory 35, the storage 36, the CPU 37, the shake amount detection sensor 40, and the UI system device 43 are connected to a bus 38. Further, the OIS driver 23 is connected to the bus 38. In the example shown in FIG. 4, one bus is illustrated as the bus 38 for convenience of illustration, but a plurality of buses may be used. The bus 38 may be a serial bus or may be a parallel bus such as a data bus, an address bus, and a control bus.

The memory 35 temporarily stores various types of information, and is used as a work memory. A random access memory (RAM) is exemplified as an example of the memory 35, but the present disclosure is not limited thereto. Another type of storage device may be used. The storage 36 stores various programs for the surveillance camera 10. The CPU 37 reads out various programs from the storage 36 and executes the readout various programs on the memory 35 to control the entire surveillance camera 10. An example of the storage 36 includes a flash memory, SSD, EEPROM, HDD, or the like. Further, for example, various non-volatile memories such as a magnetoresistive memory and a ferroelectric memory may be used instead of the flash memory or together with the flash memory.

The imaging element 25 is a complementary metal oxide semiconductor (CMOS) image sensor. The imaging element 25 images a target subject at a predetermined frame rate under an instruction of the CPU 37. The term “predetermined frame rate” described herein refers to, for example, several tens of frames/second to several hundreds of frames/second. The imaging element 25 may incorporate a control device (imaging element control device). In this case, the imaging element control device performs detailed control inside the imaging element 25 in response to the imaging instruction output by the CPU 37. Further, the imaging element 25 may image the target subject at the predetermined frame rate under an instruction of the DSP 31. In this case, the imaging element control device performs detailed control inside the imaging element 25 in response to the imaging instruction output by the DSP 31. The DSP 31 may be referred to as an image signal processor (ISP).

The light-receiving surface 25A of the imaging element 25 is formed by a plurality of photosensitive pixels (not illustrated) arranged in a matrix. In the imaging element 25, each photosensitive pixel is exposed, and photoelectric conversion is performed for each photosensitive pixel. A charge obtained by performing the photoelectric conversion for each photosensitive pixel corresponds to an analog imaging signal indicating the target subject. Here, a plurality of photoelectric conversion elements (for example, photoelectric conversion elements in which color filters are disposed) having sensitivity to visible light are employed as the plurality of photosensitive pixels. In the imaging element 25, the photoelectric conversion element having sensitivity to R (red) light (for example, photoelectric conversion element in which an R filter corresponding to R is disposed), the photoelectric conversion element having sensitivity to G (green) light (for example, photoelectric conversion element in which a G filter corresponding to G is disposed), and the photoelectric conversion element having sensitivity to B (blue) light (for example, photoelectric conversion element in which a B filter corresponding to B is disposed) are employed as the plurality of photoelectric conversion elements. In the surveillance camera 10, these photosensitive pixels are used to perform the imaging based on the visible light (for example, light on a short wavelength side of about 700 nanometers or less). However, the present embodiment is not limited thereto. The imaging based on infrared light (for example, light on a wavelength side longer than about 700 nanometers) may be performed. In this case, the plurality of photoelectric conversion elements having sensitivity to the infrared light may be used as the plurality of photosensitive pixels. In particular, for example, an InGaAs sensor and/or a simulation of type-II quantum well (T2SL) sensor may be used for short-wavelength infrared (SWIR) imaging.

The imaging element 25 performs signal processing such as analog/digital (A/D) conversion on the analog imaging signal to generate a digital image that is a digital imaging signal. The imaging element 25 is connected to the DSP 31 via the bus 38 and outputs the generated digital image to the DSP 31 in units of frames via the bus 38.

Here, the CMOS image sensor is exemplified for description as an example of the imaging element 25, but the technique of the present disclosure is not limited thereto. A charge coupled device (CCD) image sensor may be employed as the imaging element 25. In this case, the imaging element 25 is connected to the bus 38 via an analog front end (AFE) (not illustrated) that incorporates a CCD driver. The AFE performs the signal processing, such as the A/D conversion, on the analog imaging signal obtained by the imaging element 25 to generate the digital image and output the generated digital image to the DSP 31. The CCD image sensor is driven by the CCD driver incorporated in the AFE. Of course, the CCD driver may be independently provided.

The DSP 31 performs various types of digital signal processing on the digital image. For example, the various types of digital signal processing refer to demosaicing processing, noise removal processing, gradation correction processing, and color correction processing. The DSP 31 outputs the digital image after the digital signal processing to the image memory 32 for each frame. The image memory 32 stores the digital image from the DSP 31.

The shake amount detection sensor 40 is, for example, a device including a gyro sensor, and detects the shake amount of the surveillance camera 10. In other words, the shake amount detection sensor 40 detects the shake amount in each of a pair of axial directions. The gyro sensor detects a rotational shake amount around respective axes (see FIG. 1) of the pitch axis PA, the yaw axis YA, and a roll axis RA (axis parallel to the optical axis OA). The shake amount detection sensor 40 converts the rotational shake amount around the pitch axis PA and the rotational shake amount around the yaw axis YA, which are detected by the gyro sensor, into the shake amount in a two-dimensional plane parallel to the pitch axis PA and the yaw axis YA to detect the shake amount of the surveillance camera 10.

Here, the gyro sensor is exemplified as an example of the shake amount detection sensor 40, but this is merely an example. The shake amount detection sensor 40 may be an acceleration sensor. The acceleration sensor detects the shake amount in the two-dimensional plane parallel to the pitch axis PA and the yaw axis YA. The shake amount detection sensor 40 outputs the detected shake amount to the CPU 37.

Further, although the form example is shown in which the shake amount is detected by a physical sensor called the shake amount detection sensor 40, the technique of the present disclosure is not limited thereto. For example, a movement vector obtained by comparing preceding and succeeding captured images in time series, which are stored in the image memory 32, may be used as the shake amount. Further, the shake amount to be finally used may be derived based on the shake amount detected by the physical sensor and the movement vector obtained by the image processing.

The CPU 37 acquires the shake amount detected by the shake amount detection sensor 40 and controls the lens-side shake correction mechanism 29, the imaging element-side shake correction mechanism 45, and the electronic shake correction unit 33 based on the acquired shake amount. The shake amount detected by the shake amount detection sensor 40 is used for the shake correction by each of the lens-side shake correction mechanism 29 and the electronic shake correction unit 33.

The electronic shake correction unit 33 is a device including an application specific integrated circuit (ASIC). The electronic shake correction unit 33 performs the image processing on the captured image in the image memory 32 based on the shake amount detected by the shake amount detection sensor 40 to correct the shake.

Here, the device including the ASIC is exemplified as the electronic shake correction unit 33, but the technique of the present disclosure is not limited thereto. For example, a device including a field programmable gate array (FPGA) or a programmable logic device (PLD) may be used. Further, for example, the electronic shake correction unit 33 may be a device including a plurality of ASICs, FPGAs, and PLDs. Further, a computer including a CPU, a storage, and a memory may be employed as the electronic shake correction unit 33. The number of CPUs may be singular or plural. Further, the electronic shake correction unit 33 may be implemented by a combination of a hardware configuration and a software configuration.

The communication I/F 34 is, for example, a network interface, and controls transmission of various types of information to and from the management apparatus 11 via a network. The network is, for example, a wide area network (WAN) or a local area network (LAN), such as the Internet. The communication I/F 34 performs communication between the surveillance camera 10 and the management apparatus 11.

The UI system device 43 comprises a reception device 43A and a display 43B. The reception device 43A is, for example, a hard key, a touch panel, and the like, and receives various instructions from a user. The CPU 37 acquires various instructions received by the reception device 43A and operates in response to the acquired instructions.

The display 43B displays various types of information under the control of the CPU 37. Examples of the various types of information displayed on the display 43B include a content of various instructions received by the reception device 43A and the captured image.

### <Configuration of Electrical System of Revolution Mechanism 16 and Management Apparatus 11>

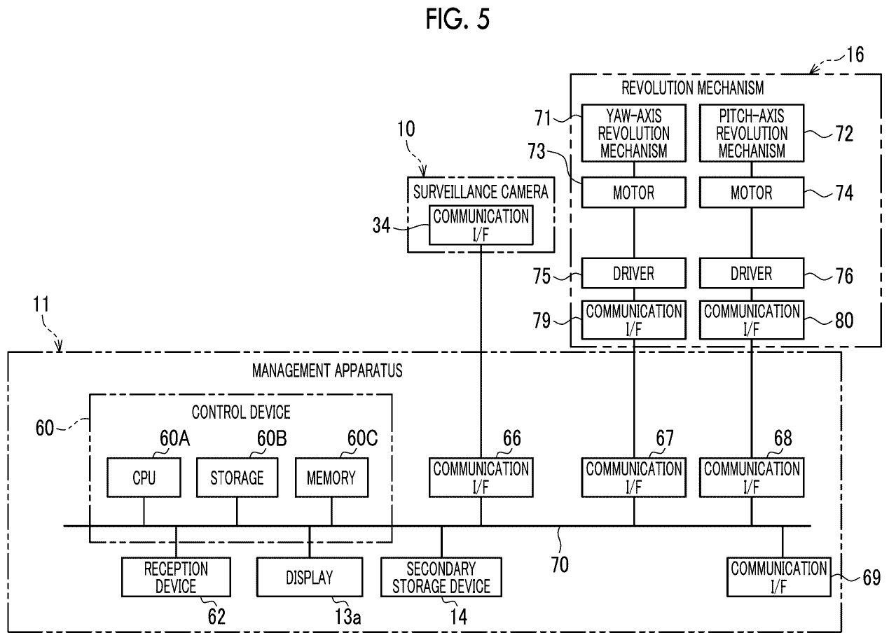

FIG. 5 is a diagram showing an example of a configuration of an electrical system of the revolution mechanism 16 and the management apparatus 11. As shown in FIG. 5 as an example, the revolution mechanism 16 comprises a yaw-axis revolution mechanism 71, a pitch-axis revolution mechanism 72, motors 73 and 74, drivers 75 and 76, and communication I/Fs 79 and 80.

The yaw-axis revolution mechanism 71 causes the surveillance camera 10 to revolve in the yaw direction. The motor 73 is driven to generate the power under the control of the driver 75. The yaw-axis revolution mechanism 71 receives the power generated by the motor 73 to cause the surveillance camera 10 to revolve in the yaw direction. The pitch-axis revolution mechanism 72 causes the surveillance camera 10 to revolve in the pitch direction. The motor 74 is driven to generate the power under the control of the driver 76. The pitch-axis revolution mechanism 72 receives the power generated by the motor 74 to cause the surveillance camera 10 to revolve in the pitch direction.

The communication I/Fs 79 and 80 are, for example, network interfaces, and control transmission of various types of information to and from the management apparatus 11 via the network. The network is, for example, a WAN or a LAN, such as the Internet. The communication I/Fs 79 and 80 performs communication between the revolution mechanism 16 and the management apparatus 11.

As shown in FIG. 5 as an example, the management apparatus 11 comprises the display 13a, the secondary storage device 14, a control device 60, a reception device 62, and communication I/Fs 66, 67, 68, and 69. The control device 60 comprises a CPU 60A, a storage 60B, and a memory 60C. The CPU 60A is an example of the processor in the embodiment of the present invention.

Each of the reception device 62, the display 13a, the secondary storage device 14, the CPU 60A, the storage 60B, the memory 60C, and the communication I/F 66 is connected to a bus 70. In the example shown in FIG. 5, one bus is illustrated as the bus 70 for convenience of illustration, but a plurality of buses may be used. The bus 70 may be a serial bus or may be a parallel bus including a data bus, an address bus, a control bus, and the like.

The memory 60C temporarily stores various types of information and is used as the work memory. An example of the memory 60C includes the RAM, but the present disclosure is not limited thereto. Another type of storage device may be employed. Various programs for the management apparatus 11 (hereinafter simply referred to as “program for management apparatus”) are stored in the storage 60B.

The CPU 60A reads out the program for a management apparatus from the storage 60B and executes the readout program for a management apparatus on the memory 60C to control the entire management apparatus 11. The program for a management apparatus includes a management program according to the embodiment of the present invention.

The communication I/F 66 is, for example, a network interface. The communication I/F 66 is communicably connected to the communication I/F 34 of the surveillance camera 10 via the network, and controls transmission of various types of information to and from the surveillance camera 10. The communication I/Fs 67 and 68 are, for example, network interfaces. The communication I/F 67 is communicably connected to the communication I/F 79 of the revolution mechanism 16 via the network, and controls transmission of various types of information to and from the yaw-axis revolution mechanism 71. The communication I/F 68 is communicably connected to the communication I/F 80 of the revolution mechanism 16 via the network, and controls transmission of various types of information to and from the pitch-axis revolution mechanism 72.

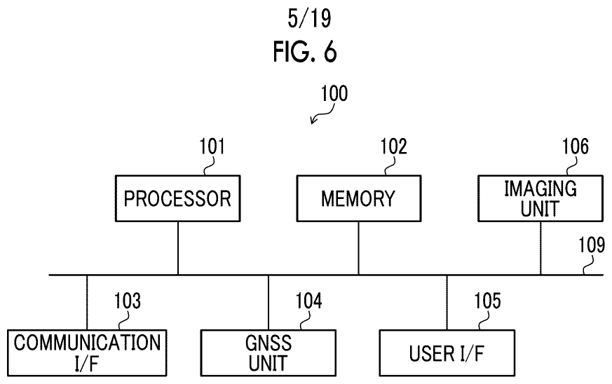

The communication I/F 69 is, for example, a network interface. In a region of a surveillance target (imaging target) by the imaging system 1 (hereinafter, referred to as a “surveillance target region”), a plurality of workers are present, and each worker possesses a terminal device (for example, see FIG. 6) such as a smartphone. The communication I/F 69 directly or indirectly performs communication with the terminal device possessed by each worker in the surveillance target region via the network. The terminal device is an example of a second imaging apparatus according to the embodiment of the present invention. The network is, for example, a WAN or a LAN. The surveillance target region is, for example, a place where dangerous work is performed by a plurality of workers, and is an example of a construction site, a disaster site, and the like.

The CPU 60A receives the captured image, the imaging information, and the like from the surveillance camera 10 via the communication I/F 66 and the communication I/F 34. The CPU 60A controls the imaging operation of the imaging target by the surveillance camera 10 via the communication I/F 66 and the communication I/F 34.

The CPU 60A controls the driver 75 and the motor 73 of the revolution mechanism 16 via the communication I/F 67 and the communication I/F 79 to control a revolution operation of the yaw-axis revolution mechanism 71. Further, the CPU 60A controls the driver 76 and the motor 74 of the revolution mechanism 16 via the communication I/F 68 and the communication I/F 80 to control the revolution operation of the pitch-axis revolution mechanism 72.

The CPU 60A transmits and receives the captured image, the imaging information, and the like to and from the terminal device via the communication I/F 69 and the communication I/F 103 (see FIG. 6).

The CPU 60A acquires attribute information (e.g., identification information) of the terminal device based on at least one of a result of image processing on the first imaging data acquired by the surveillance camera 10 or information related to the imaging of the surveillance camera 10. The image processing on the first imaging data is to recognize a target (for example, a worker) in the image by image analysis. The information related to the imaging of the surveillance camera 10 is an imaging range designated by the longitude and latitude set based on the imaging direction (pan/tilt value) of the surveillance camera 10. The imaging range is set based on the position information associated with the imaging direction. The imaging range may be set in consideration of the angle of view in addition to the imaging direction. The CPU 60A acquires the attribute information of the terminal device based on the imaging range and the GPS information of a plurality of the terminal devices. In a case of acquiring the attribute information of the terminal device based on the result of the image processing, the CPU 60A acquires the attribute information based on the recognition result of the possessor of the terminal device or the installation target of the terminal device (for example, the terminal device installed in the robot, the terminal device installed in the vehicle, or the like). The attribute information of the terminal device is associated with a possessor of the terminal device and a setting target.

The CPU 60A transmits, to a predetermined terminal device, imaging instruction information indicating an imaging condition of a subject imaged by the terminal device, based on the acquired attribute information of the terminal device. The imaging instruction information indicating the imaging condition is designated by the user of the management apparatus 11. The imaging instruction information is transmitted as, for example, instruction information such as “please image a portion a in the region A”. The imaging condition is a condition for supplementing a shortage of the first imaging data acquired by the surveillance camera 10. The imaging condition is indicated by a fixed tool such as an electronic mail, Teams (registered trademark), or Line (registered trademark). The CPU 60A causes the display 13a to output at least one of a first captured image represented by the first imaging data or a second captured image represented by the second imaging data acquired by the terminal device, and receives designation of the imaging condition from the user.

The CPU 60A causes the surveillance camera 10 to image a predetermined image designated based on at least one of the position information of the terminal device or the imaging condition designated from the terminal device. The predetermined image to be imaged based on the position information of the terminal device is, for example, a peripheral image of a position where the terminal device is present. The predetermined image to be imaged based on the imaging condition designated from the terminal device is, for example, a peripheral image of a position designated by the terminal device. The CPU 60A transmits first imaging data of the predetermined image captured by the surveillance camera 10 to a predetermined terminal device. In a case of communicating with the terminal device, the CPU 60A may cause the display 13a to output, for example, at least one of the first captured image represented by the first imaging data acquired by the surveillance camera 10 or the second captured image represented by the second imaging data acquired by the terminal device. The CPU 60A holds correspondence information between a revolution control value (pan/tilt value) of the revolution mechanism 16 and the position (longitude and latitude) of the imaging target by the surveillance camera 10 in the memory 60C or the secondary storage device 14.

The reception device 62 is, for example, the keyboard 13b, the mouse 13c, and a touch panel of the display 13a, and receives various instructions from the user. The CPU 60A acquires various instructions received by the reception device 62 and operates in response to the acquired instructions. For example, in a case where the reception device 62 receives a processing content for the surveillance camera 10 and/or the revolution mechanism 16, the CPU 60A causes the surveillance camera 10 and/or the revolution mechanism 16 to operate in accordance with an instruction content received by the reception device 62.

The display 13a displays various types of information under the control of the CPU 60A. Examples of the various types of information displayed on the display 13a include contents of various instructions received by the reception device 62 and the captured image or imaging information received by the communication I/F 66. The CPU 60A causes the display 13a to output the contents of various instructions received by the reception device 62 and the captured image or imaging information received by the communication I/F 66.

The secondary storage device 14 is, for example, a non-volatile memory and stores various types of information under the control of the CPU 60A. An example of the various types of information stored in the secondary storage device 14 includes the captured image or imaging information received by the communication I/F 66. The CPU 60A stores the captured image or imaging information received by the communication I/F 66 in the secondary storage device 14.

### <Hardware Configuration of Terminal Device Possessed by Worker in Surveillance Target Region>

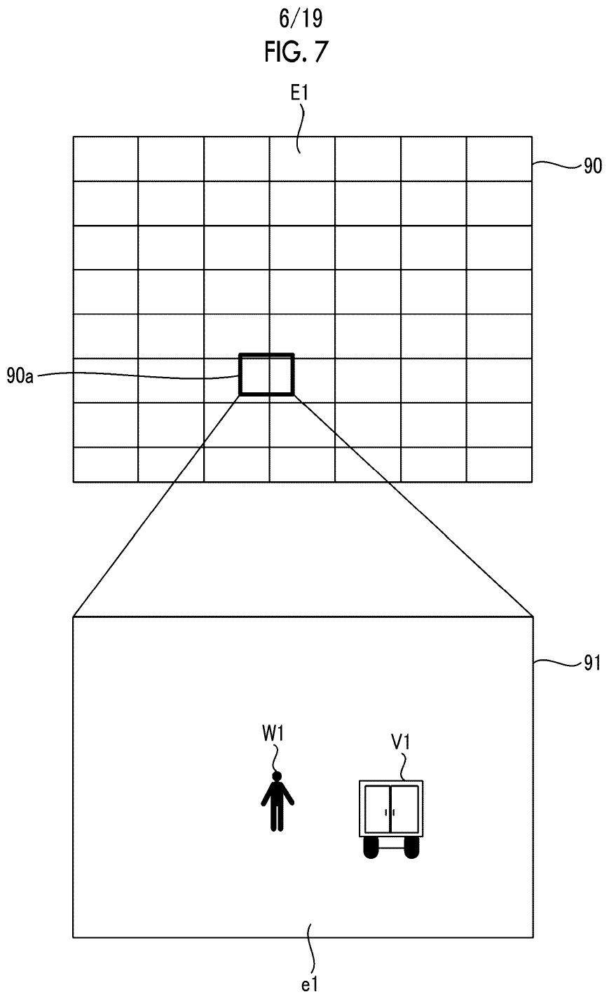

FIG. 6 is a diagram showing an example of a hardware configuration of a terminal device possessed by a worker in a surveillance target region. A worker of the surveillance target region (for example, a worker W1 of the surveillance target region E1 shown in FIG. 7) possesses a terminal device 100 as shown in FIG. 6. The terminal device 100 comprises a processor 101, a memory 102, a communication I/F 103, a global navigation satellite system (GNSS) unit 104, a user I/F 105, and an imaging unit 106. The processor 101, the memory 102, the communication I/F 103, the GNSS unit 104, the user I/F 105, and the imaging unit 106 are connected to each other through, for example, a bus 109.

The processor 101 is a circuit that performs signal processing, and is, for example, a CPU that performs control of the entire terminal device 100. The processor 101 may be implemented by another digital circuit, such as an FPGA or a DSP. In addition, the processor 101 may be implemented by combining a plurality of digital circuits with each other.

The memory 102 includes, for example, a main memory and an auxiliary memory. The main memory is, for example, a RAM. The main memory is used as a work area of the processor 101. The auxiliary memory is, for example, a non-volatile memory such as a magnetic disk, an optical disk, or a flash memory. The auxiliary memory stores various programs for operating the terminal device 100. The programs stored in the auxiliary memory are loaded into the main memory and executed by the processor 101.

In addition, the auxiliary memory may include a portable memory that can be detached from the terminal device 100. Examples of the portable memory include a memory card such as a universal serial bus (USB) flash drive or a secure digital (SD) memory card, and an external hard disk drive.

The communication I/F 103 is a communication interface that performs wireless communication with the outside of the terminal device 100. For example, the communication I/F 103 indirectly performs communication with the management apparatus 11 by being connected to the Internet via the moving object communication network. The communication I/F 103 is controlled by the processor 101.

The GNSS unit 104 is, for example, a satellite positioning system such as a global positioning system (GPS), and acquires position information (longitude and latitude) of the terminal device 100. The GNSS unit 104 is controlled by the processor 101.

The user I/F 105 includes, for example, an input device that receives an operation input from the user, and an output device that outputs information to the user. The input device can be implemented by, for example, a key (for example, a keyboard) or a remote controller. The output device can be implemented by, for example, a display or a speaker. In addition, the input device and the output device may be implemented by a touch panel or the like. The user I/F 105 is controlled by the processor 101.

The imaging unit 106 is a portion having a function of imaging the surveillance target region that is an imaging target. The imaging unit 106 is controlled by the processor 101.

### <Image Displayed by Management Apparatus 11>

FIG. 7 is a diagram showing an example of an image displayed by the management apparatus 11. The management apparatus 11 can display, for example, the wide area image 90 and the detailed image 91 on the display 13a for a user (for example, surveillant of the surveillance target region E1) of the management apparatus 11. In this example, it is assumed that the angle of view of the surveillance camera 10 is an angle of view in which only a partial region of the surveillance target region can be imaged.

The wide area image 90 is a pseudo wide-angle image representing the entire surveillance target region E1, which is generated by the management apparatus 11 controlling the surveillance camera 10 and the revolution mechanism 16 to cause the surveillance camera 10 to image each region of the surveillance target region E1 for a plurality of times and to combine (connect) each imaging information obtained by the imaging. The pseudo wide-angle image is an example of a first composite image according to the embodiment of the present invention. This series of imaging control and the generation of the wide area image 90 are performed periodically, for example, at a predetermined time (for example, 7:00 in the morning) every day.

The detailed image 91 is an image that is generated from the latest imaging information obtained by the imaging of the surveillance camera 10 and that represents a partial region e1 of the surveillance target region E1 in real time.

The wide area image 90 and the detailed image 91 may be displayed, for example, simultaneously side by side, or may be displayed by being switched between each other according to an operation or the like from the user of the management apparatus 11.

The wide area image 90 includes a region designation cursor 90a. The user of the management apparatus 11 can change the position or the size of the region designation cursor 90a by operating the reception device 62.

For example, the memory 60C of the management apparatus 11 or the secondary storage device 14 stores correspondence information in which the coordinates of the wide area image 90, the longitude and latitude (longitude and latitude) of the position corresponding to the coordinates in the surveillance target region E1, and the control parameter (control values of the pan and the tilt of the surveillance camera 10) of the revolution mechanism 16 for imaging the surveillance camera 10 with the position corresponding to the coordinates in the surveillance target region E1 as the center are uniquely associated with each other.

For example, the management apparatus 11 derives a correspondence relationship between the coordinates of the wide area image 90 and the control parameter of the revolution mechanism 16 in the generation of the wide area image 90 described above. In addition, for example, the management apparatus 11 adjusts the control parameter of the revolution mechanism 16 such that the surveillance camera 10 can image the plurality of positions included in the surveillance target region E1 and having known longitude and latitude as the center of the position, and derives the correspondence relationship between the control parameter of the revolution mechanism 16 and the longitude and latitude by associating the adjusted control parameter with the longitude and latitude (known) of the position. As a result, it is possible to generate the correspondence information in which the coordinates of the wide area image 90, the control parameter of the revolution mechanism 16, and the longitude and latitude are associated with each other.

In a case where the region designation cursor 90a is set by the operation from the user, the management apparatus 11 acquires the control parameter of the revolution mechanism 16 corresponding to the coordinate of the center of the region designated by the region designation cursor 90a in the wide area image 90 from the correspondence information, and sets the acquired control parameter in the revolution mechanism 16. As a result, the detailed image 91 representing the region in the surveillance target region E1 designated by the region designation cursor 90a by the user of the management apparatus 11 is displayed.

That is, the user of the management apparatus 11 can view the entire surveillance target region E1 by the wide area image 90. In addition, in a case where the user of the management apparatus 11 wants to view the partial region e1 of the surveillance target region E1 in detail, the user can view the detailed image 91, which represents the partial region e1 in detail, by setting the region designation cursor 90a to a part of the partial region e1 in the wide area image 90. In the example shown in FIG. 7, the entire image of the construction site is shown in the wide area image 90, and a dump truck V1 and the worker W1 are shown in the detailed image 91.

As described above, by using the real-time imaging information obtained by the surveillance camera 10 and the pseudo wide-angle image generated by combining each imaging information obtained by imaging each region of the surveillance target region E1 with the surveillance camera 10, it is possible to display both the wide area image 90 and the detailed image 91 by the set of the surveillance camera 10 and the revolution mechanism 16.

### <First Form of Processing by Management Apparatus 11>

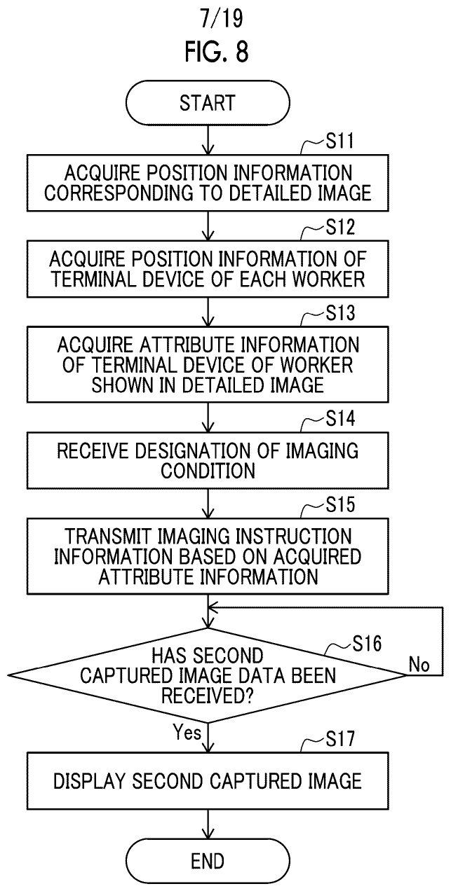

FIG. 8 is a flowchart showing an example of a first form of processing by the management apparatus 11. The first form of the processing by the management apparatus 11 is processing in which the management apparatus 11 causes the terminal device 100 to capture an image by, for example, an imaging request from the management apparatus 11 side and receives the captured image from the terminal device 100.

For example, it is assumed that a plurality of workers perform work at a certain construction site and the construction site is captured by the surveillance camera 10 installed at a place where the construction site can be viewed. The worker possesses the terminal device 100. The management apparatus 11 displays, on the display 13a, the detailed image 91 (for example, see FIG. 7) representing a region designated by the region designation cursor 90a in the wide area image 90 (for example, see FIG. 7) consisting of a plurality of the surveillance target regions E1 of the construction site captured by the surveillance camera 10. In a case where an operation of transmitting the instruction information from the user (surveillant) to the detailed image 91 displayed on the display 13a (for example, an operation of a start button on a menu screen) is performed, the management apparatus 11 executes the processing of the first form shown in FIG. 8. As described above, the management apparatus 11 stores the correspondence information in which the coordinates of the wide area image 90, the control parameter of the revolution mechanism 16, and the longitude and latitude are associated with each other.

First, the management apparatus 11 acquires the position information corresponding to the current detailed image 91 (step S11). The position information corresponding to the detailed image 91 is longitude and latitude information of the imaging target (partial region e1) associated with the captured image (detailed image 91) by the surveillance camera 10 and the revolution mechanism 16. The position information corresponding to the detailed image 91 is, for example, the longitude and latitude information of a point shown at the center of the detailed image 91. In addition, the position information corresponding to the detailed image 91 may be, for example, the longitude and latitude information of the imaging target associated with the captured image in which the angle of view is also considered. For example, the management apparatus 11 acquires the position information (longitude and latitude information) corresponding to the current control parameter of the revolution mechanism 16 as the position information (longitude and latitude information) corresponding to the current detailed image 91, based on the correspondence information described above.

Next, the management apparatus 11 acquires the position information of the terminal device 100 possessed by each worker in the surveillance target region E1 (step S12). The position information is the position information of the terminal device 100 obtained by the terminal device 100 in the imaging region (surveillance target region E1) in which the surveillance camera 10 and the revolution mechanism 16 can perform imaging.

The terminal device 100 of each worker in the surveillance target region E1 repeatedly transmits the GPS information of the terminal device 100 acquired by the GNSS unit 104 of the terminal device 100 to the management apparatus 11. On the other hand, in step S12, the management apparatus 11 acquires the latest position information from the received position information for each of the terminal devices 100 of each worker in the surveillance target region E1.

Alternatively, in step S12, the management apparatus 11 may transmit a request signal for requesting the transmission of the position information to the terminal device 100 of each worker in the surveillance target region E1, and may acquire the position information transmitted from the terminal device 100 in response to the request signal.

Next, the management apparatus 11 acquires the attribute information of the terminal device 100 of the worker W1 (see FIG. 7) shown in the detailed image 91 based on the position information corresponding to the detailed image 91 acquired in step S11 and the position information of the terminal device 100 acquired in step S12 (step S13). The attribute information of the terminal device 100 is, for example, a camera ID assigned to each terminal device 100. The attribute information of the terminal device 100 is acquired in an imaging range (for example, the detailed image 91) set based on an imaging direction (pan/tilt value) of the surveillance camera 10. The attribute information of the terminal device 100 may be acquired in an imaging range set in consideration of the angle of view of the surveillance camera 10. In a case where a plurality of workers are shown in the detailed image 91, the management apparatus 11 may receive selection of the worker from the user.

Next, the management apparatus 11 receives, from the user of the management apparatus 11, designation of the imaging condition for causing the terminal device 100 from which the attribute information is acquired in step S13 to image the designated image (step S14). The imaging condition is created as, for example, message information input from the reception device 62 (for example, the keyboard 13b or the like). In a case where the surveillance target region is a construction site, the imaging condition is created as imaging instruction information for supplementing the insufficient image that cannot be acquired by the imaging of the surveillance camera 10, for example, “please perform the imaging because I want to know the information of the front side of the dump truck V1 (see FIG. 7) and the information of the driver's seat”. The management apparatus 11 may support the designation of the imaging condition by displaying, for example, a template or an option of the imaging condition on the display 13a.

Next, the management apparatus 11 transmits the imaging instruction information received in step S14 to the worker W1 who possesses the terminal device 100, based on the attribute information of the terminal device 100 acquired in step S13, for example, by an electronic mail (step S15). The imaging instruction information to be transmitted includes information on a transmission destination to which the image data captured by the terminal device 100 is to be transmitted, for example, an e-mail address of the management apparatus 11.

Next, the management apparatus 11 determines whether or not the captured image data (second captured image data) captured by the terminal device 100 has been received from the terminal device 100 that has transmitted the imaging instruction information in step S15 (step S16).

In step S16, in a case where the second captured image data has not been received from the terminal device 100 (step S16: No), the management apparatus 11 waits until the second captured image data is received. In step S16, in a case where the second captured image data has been received from the terminal device 100 (step S16: Yes), the management apparatus 11 displays the received second captured image data on the display 13a (step S17). The management apparatus 11 may store the received second captured image data in the memory 60C or the secondary storage device 14 in association with the detailed image 91 displayed on the display 13a in step S11.

The first form of the processing by the management apparatus 11 described above is started from a state in which the detailed image 91 is displayed on the display 13a, but the present disclosure is not limited thereto. For example, the wide area image 90 (pseudo wide-angle image) may be displayed on the display 13a, and the same processing of the first form may be started even in a case where the predetermined coordinates in the wide area image 90 are designated by the user.

As described above, according to the first form of the processing by the management apparatus 11, it is possible to image a specific region that is difficult to image in detail by the surveillance camera 10 installed at a place where the construction site is viewed, by using the terminal device 100 of the worker who works at the construction site. Accordingly, the images captured by the surveillance camera 10 and the terminal device 100, which are different in the distance to the imaging target, can be mutually utilized.

### <First Form of Processing by Imaging System 1>

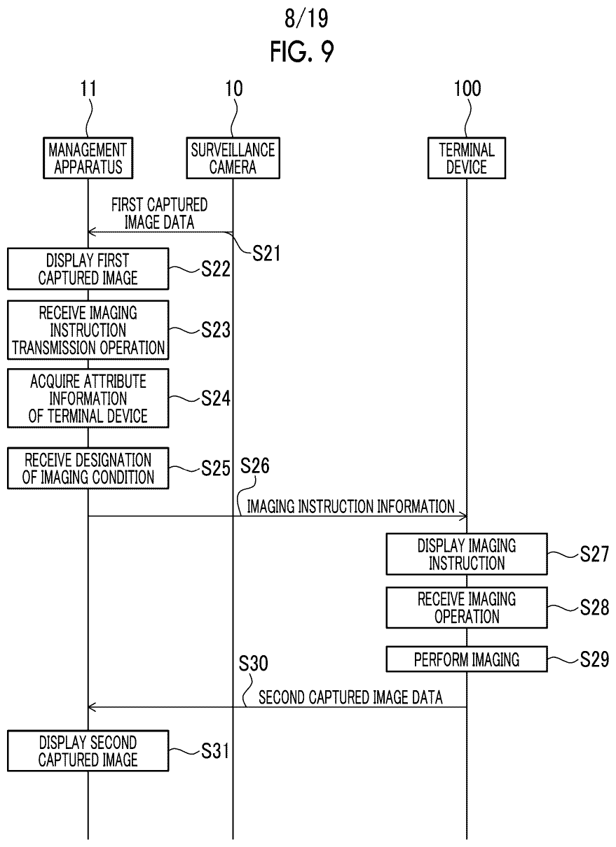

FIG. 9 is a sequence diagram showing an example of the first form of processing by the imaging system 1. The first form of the processing by the imaging system 1 is, for example, processing in which the management apparatus 11 makes the imaging request for the terminal device 100 to perform imaging of image information that is insufficient only with the captured image of the surveillance camera 10 and the terminal device 100 transmits the captured image to the management apparatus 11 in response to the request.

For example, in a certain construction site, the surveillance camera 10 is installed at a place where the construction site can be viewed. The state of the construction site is imaged by the surveillance camera 10. At the construction site, a plurality of workers perform work. The worker possesses the terminal device 100. A user (surveillant) is present in the management room in which the management apparatus 11 is installed, and surveils the construction site.

First, the surveillance camera 10 transmits the captured image data (first imaging data) of the captured construction site to the management apparatus 11 (step S21). The surveillance camera 10 images the entire region of the construction site by dividing the entire region into a plurality of surveillance target regions E1, and transmits the captured image data of each surveillance target region E1, which is captured, to the management apparatus 11.

Next, the management apparatus 11 receives the first imaging data transmitted from the surveillance camera 10 and displays the wide area image 90 (first captured image) consisting of the plurality of surveillance target regions E1 on the display 13a (step S22).

Next, the management apparatus 11 receives an imaging instruction transmission operation from the user (step S23). The imaging instruction transmission operation is an operation of starting an imaging instruction for causing the terminal device 100 to capture a predetermined image. For example, the imaging instruction transmission operation includes a touch operation of an imaging instruction start button on the menu screen displayed on the display 13a and an operation of designating the terminal device 100 that is to capture a predetermined image. The designation of the terminal device 100 that is to capture the predetermined image is performed by an operation of the region designation by the region designation cursor 90a. The region designation is performed such that any worker is included in the region designation cursor 90a in the wide area image 90.

Next, the management apparatus 11 acquires the attribute information of the terminal device 100 (step S24). By the region designation in step S23, the detailed image 91 (for example, see FIG. 7) representing the region designated by the region designation cursor 90a is displayed on the display 13a of the management apparatus 11. First, the management apparatus 11 acquires the position information corresponding to the detailed image 91. The management apparatus 11 acquires, for example, the position information (longitude and latitude information) corresponding to the current control parameter of the revolution mechanism 16 as the position information (longitude and latitude information) corresponding to the detailed image 91, based on the correspondence information described above. Next, the management apparatus 11 acquires the position information (GPS information) of the terminal device 100 possessed by the worker in the detailed image 91. Next, the management apparatus 11 acquires the attribute information of the terminal device 100 of, for example, the worker W1 (see FIG. 7) shown in the detailed image 91 based on the position information corresponding to the detailed image 91 and the position information of the terminal device 100.

Next, the management apparatus 11 receives, from the user, designation of the imaging condition for causing the terminal device 100 to image the designated image (step S25). The imaging condition is created as imaging instruction information for supplementing the insufficient image that cannot be acquired by the imaging of the surveillance camera 10, for example, “please perform the imaging because I want to know the information of the front side of the dump truck V1 (see FIG. 7) and the information of the driver's seat”.

Next, the management apparatus 11 transmits the imaging instruction information indicating the imaging instruction including the imaging condition received in step S25 to the worker W1 who possesses the terminal device 100, based on the attribute information of the terminal device 100 acquired in step S24 (step S26).

Next, the terminal device 100 receives the imaging instruction information transmitted from the management apparatus 11 in step S26, and displays the content of the imaging instruction on the screen of the terminal device 100 (step S27). In this case, the terminal device 100 may receive the detailed image 91 captured by the surveillance camera 10 from the management apparatus 11 and display the detailed image 91 on the screen of the terminal device 100 side by side with the imaging instruction information.

Next, the terminal device 100 receives an imaging operation by the worker W1 who possesses the terminal device 100 (step S28). The worker W1 performs the imaging operation of imaging a predetermined image (front side of the dump truck, driver's seat) in accordance with the imaging instruction information. Next, the terminal device 100 captures an image by the imaging unit 106 in accordance with the imaging operation of the worker W1 (step S29).

Next, the terminal device 100 transmits the image data (second captured image data) of the image captured in step S29 to the management apparatus 11 (step S30).

Next, the management apparatus 11 receives the second captured image data transmitted from the terminal device 100 in step S30, and displays the second captured image on the display 13a (step S31).

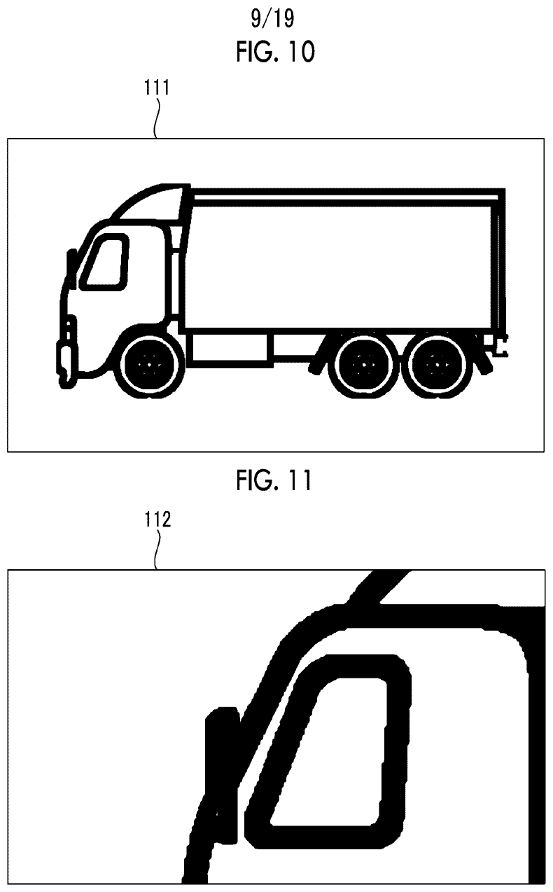

FIG. 10 is a diagram showing an example of a captured image that is captured by the terminal device 100 in response to the imaging request from the management apparatus 11 and is transmitted from the terminal device 100 to the management apparatus 11. Specifically, the captured image is a captured image 111 of “the front side of the dump truck V1” captured according to the imaging condition received from the user of the management apparatus 11 in step S14 and step S25.

FIG. 11 is a diagram showing another example of the captured image that is captured by the terminal device 100 in response to the imaging request from the management apparatus 11 and is transmitted from the terminal device 100 to the management apparatus 11. FIG. 11 is a partially enlarged view obtained by enlarging a part of the captured image 111 shown in FIG. 10. Specifically, the captured image is a captured image 112 of the “driver's seat of the dump truck V1” captured according to the imaging condition received from the user of the management apparatus 11 in step S14 and step S25.

As described above, according to the first form of the processing by the imaging system 1, it is possible to make the imaging request for the terminal device 100 of the worker who works at the construction site to perform imaging of the specific region that is difficult to image in detail by the surveillance camera 10 installed at a place where the construction site is viewed, and to transmit the image captured by the terminal device 100 in response to the request to the management apparatus 11. Accordingly, the images captured by the surveillance camera 10 and the terminal device 100, which are different in the distance to the imaging target, can be mutually utilized.

### <Modification Example 1 of Imaging System 1>

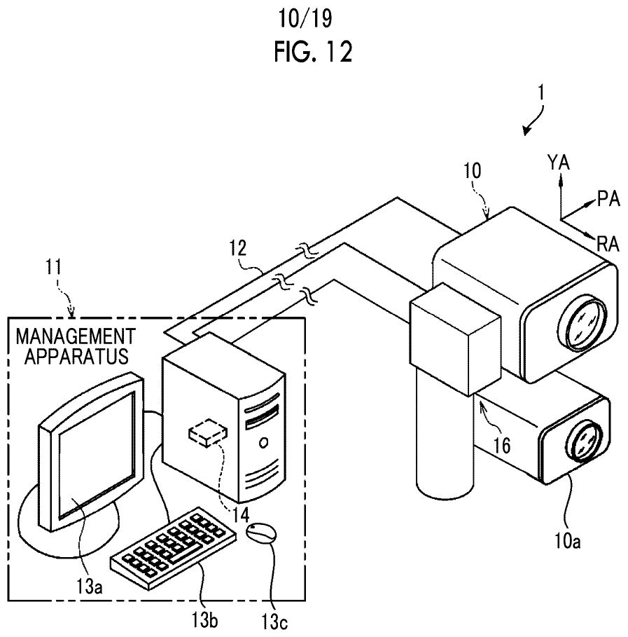

FIG. 12 is a diagram showing Modification Example 1 of the imaging system 1. As shown in FIG. 12, the imaging system 1 may include a surveillance camera 10a in addition to the configuration shown in FIG. 1. The surveillance camera 10a is a camera having a wider angle of view than the surveillance camera 10 and is installed to be able to image the entire surveillance target region E1. The configuration of the surveillance camera 10a is the same as the configuration of the surveillance camera 10 shown in FIG. 4, for example, but is different in that the optical system 15 has a wider angle optical characteristic.

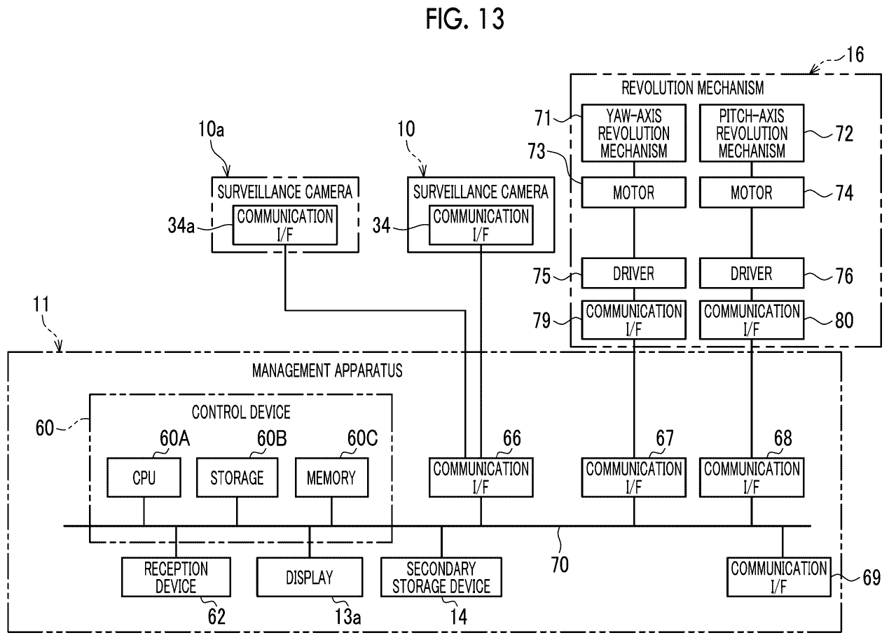

FIG. 13 is a diagram showing an example of a configuration of the electrical system of the management apparatus 11 shown in FIG. 12. In the imaging system 1 shown in FIG. 12, the surveillance camera 10a comprises a communication I/F 34a similar to the communication I/F 34 of the surveillance camera 10. The communication I/F 34a performs communication between the surveillance camera 10a and the management apparatus 11.

The communication I/F 66 of the management apparatus 11 is communicably connected to the communication I/F 34a of the surveillance camera 10a in addition to the communication I/F 34 of the surveillance camera 10, and controls transmission of various types of information to and from the surveillance cameras 10 and 10a.

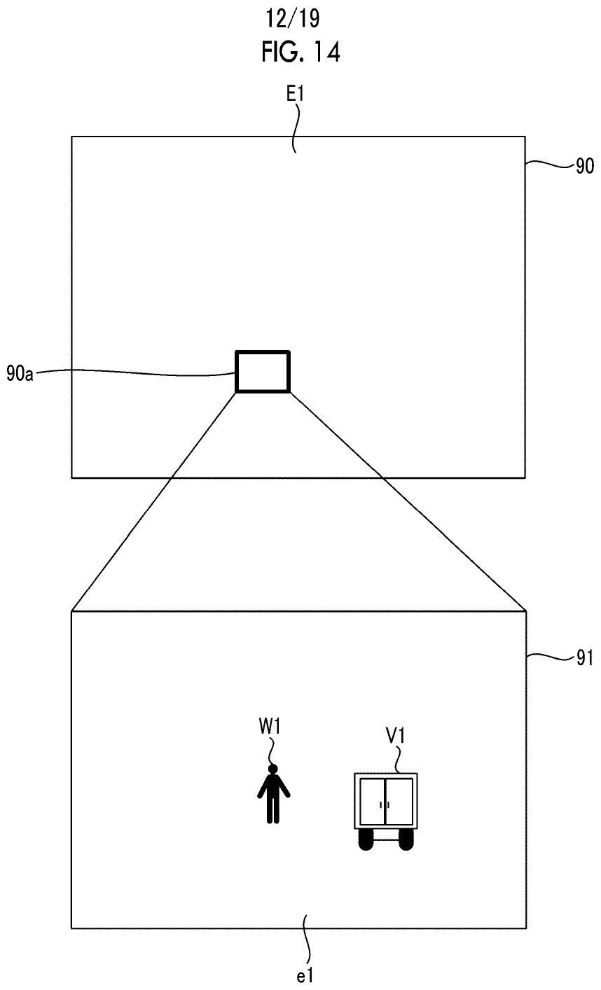

FIG. 14 is a diagram showing an example of an image displayed by the management apparatus 11 in configurations shown in FIGS. 12 and 13. In the configurations shown in FIGS. 12 and 13, the management apparatus 11 displays an image based on the imaging information obtained from the surveillance camera 10a as the wide area image 90 representing the surveillance target region E1. That is, the wide area image 90 in this case is not the pseudo wide-angle image generated by combining each imaging information obtained by imaging each region of the surveillance target region E1 with the surveillance camera 10, but is the wide-angle image based on the single imaging information obtained by the wide-angle surveillance camera 10a.

In this case, the wide area image 90 may be a non-real-time image obtained by the periodical imaging as described above, or may be a real-time image obtained from the latest imaging information obtained by the imaging of the surveillance camera 10a.

In this case as well, the management apparatus 11 stores the correspondence information in which the coordinates of the wide area image 90, the control parameter of the revolution mechanism 16, and the longitude and latitude, which are described above, are uniquely associated with each other. In this case, the control parameter of the revolution mechanism 16 and the coordinates of the wide area image 90 corresponding to the longitude and latitude are derived, for example, by the user of the management apparatus 11 designating the coordinates corresponding to the wide area image 90 for a plurality of positions included in the surveillance target region E1 and having known longitude and latitude. The management apparatus 11 executes the process shown in FIG. 8 by using the correspondence information.

### <Modification Example 2 of Imaging System 1>

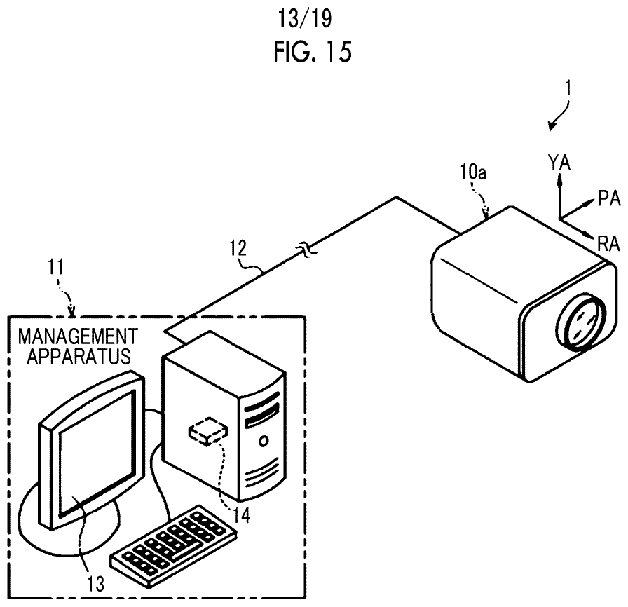

FIG. 15 is a diagram showing Modification Example 2 of the imaging system 1. As shown in FIG. 15, the imaging system 1 may have a configuration in which the surveillance camera 10 and the revolution mechanism 16 are omitted from the configuration shown in FIG. 12.

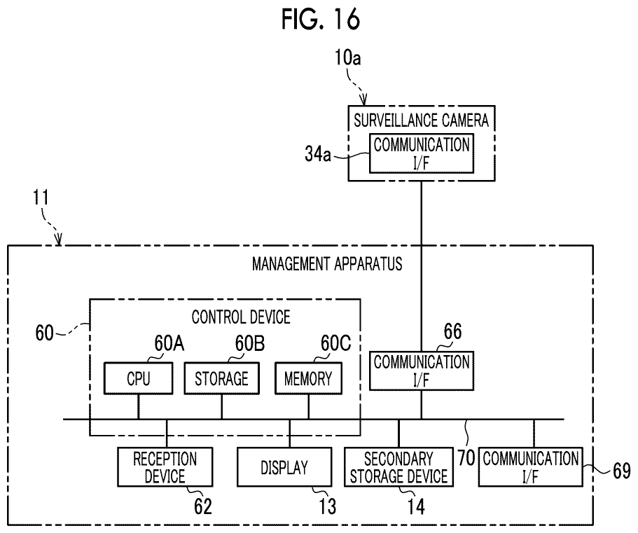

FIG. 16 is a diagram showing an example of a configuration of the electrical system of the management apparatus 11 shown in FIG. 15. In the imaging system 1 shown in FIG. 15, the management apparatus 11 has a configuration in which the communication I/F 67 and the communication I/F 68 are omitted in the configuration shown in FIG. 13. The communication I/F 66 of the management apparatus 11 is communicably connected to the communication I/F 34a of the surveillance camera 10a, and controls transmission of various types of information to and from the surveillance camera 10a.

The image displayed by the management apparatus 11 in the configurations shown in FIGS. 15 and 16 is the same as the wide area image 90 and the detailed image 91 shown in FIG. 14, for example. However, the management apparatus 11 displays a digital zoom image obtained by cutting out and enlarging a region designated by the region designation cursor 90a in the wide area image 90 as the detailed image 91 representing the partial region e1. In this case, the wide area image 90 is, for example, a real-time image obtained from the latest imaging information obtained by the imaging of the surveillance camera 10a.

In this case, the management apparatus 11 stores the correspondence information in which the coordinates of the wide area image 90 and the longitude and latitude are uniquely associated with each other. That is, in the correspondence information in this case, the control parameter of the revolution mechanism 16 is not necessary. In this case, the coordinates of the wide area image 90 corresponding to the longitude and latitude are derived, for example, by the user of the management apparatus 11 designating the coordinates corresponding to the wide area image 90 for a plurality of positions included in the surveillance target region E1 and having known longitude and latitude.

The management apparatus 11 executes the process shown in FIG. 8 by using the correspondence information. In this case, in step S11, the management apparatus 11 acquires the longitude and latitude corresponding to the detailed image 91 based on the coordinates of the region subjected to the digital zoom in the wide area image 90 and the correspondence information.

### <Checking Processing of Person in Poor Physical Condition, Injured Person, or the Like>

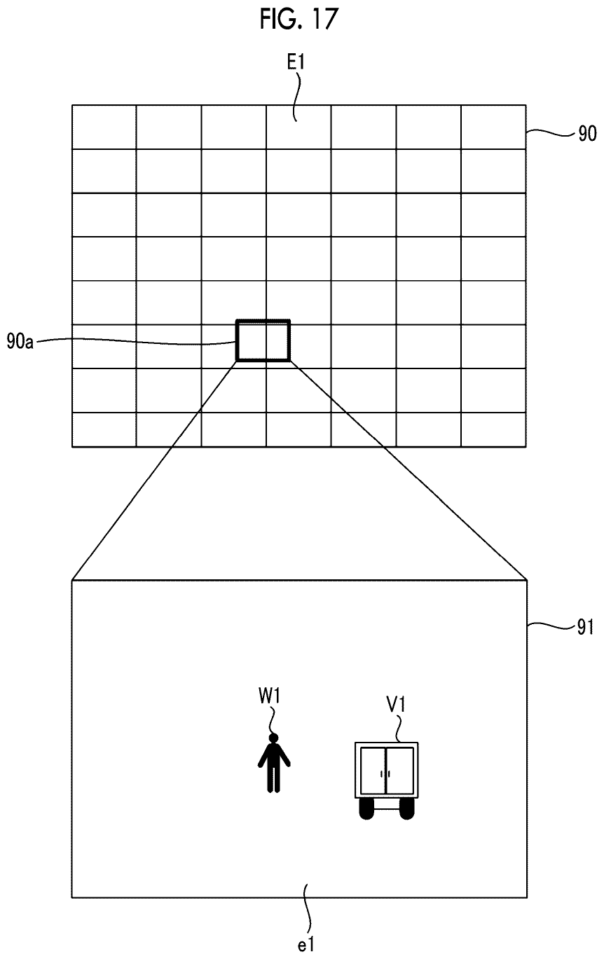

FIG. 17 is a diagram showing an example of a checking processing of a person in poor physical condition, an injured person, or the like. The imaging system 1 can also be applied to a system that can check a worker who has fallen down or cannot move due to heat stroke, injury, or the like in a surveillance target region E1 (for example, a construction site).

For example, each of the terminal devices 100 detects an abnormality of the worker who possesses the terminal device 100. The detection of the abnormality of the worker is performed based on, for example, at least any one of the fact that a state in which there is no variation in the longitude and latitude acquired by the GNSS unit 104 provided in the terminal device 100 has continued for a certain time or longer, the fact that a stationary state of the terminal device 100 detected by the acceleration sensor provided in the terminal device 100 has continued for a certain time or longer, or the fact that the biological information of the worker measured by the wearable device that is communicable with the terminal device 100 and worn by the worker is an abnormal value.

In this case, the terminal device 100 transmits abnormality detection information indicating that the abnormality of the worker is detected to the management apparatus 11 together with information on the longitude and latitude acquired by the GNSS unit 104 provided in the terminal device 100. In a case where the abnormality detection information and the information on the longitude and latitude are received, the management apparatus 11 displays the detailed image 91 of the region of the wide area image 90 corresponding to the longitude and latitude. As a result, in a case where the abnormality of the worker is detected by the terminal device 100, the detailed image 91 showing the position of the worker can be automatically displayed. Therefore, the user of the management apparatus 11 can quickly check the state of the worker in which the abnormality is detected.

In the state shown in FIG. 17, the worker W1 falls down in the partial region e1, and the terminal device 100 possessed by the worker W1 transmits the abnormality detection information and the information on the longitude and latitude to the management apparatus 11. In this case, the management apparatus 11 displays the detailed image 91 of the partial region e1 based on the information on the longitude and latitude received together with the abnormality detection information. As a result, the user of the management apparatus 11 can quickly check the state in which the worker W1 has fallen down.

Further, the user of the management apparatus 11 can transmit the instruction information inquiring about the situation to the worker W1 or transmit the instruction information for instructing rescue or the like to other workers around the worker W1 by performing the instruction information transmission operation described above in a state in which the detailed image 91 showing the worker W1 is displayed.

### <Second Form of Processing by Management Apparatus 11>

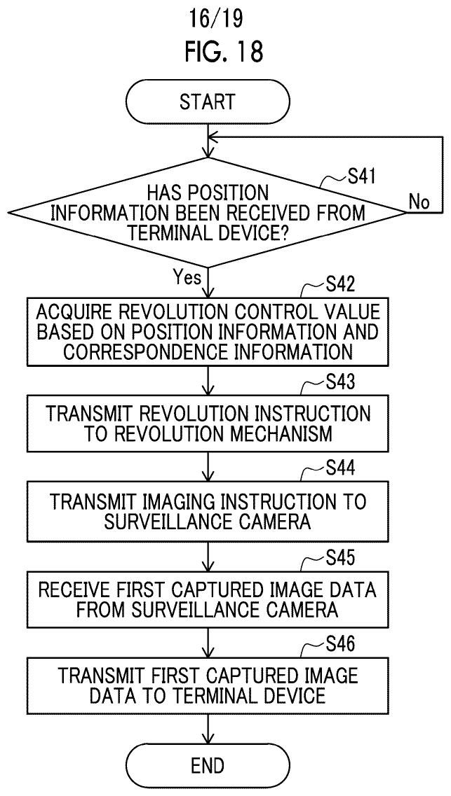

FIG. 18 is a flowchart showing an example of a second form of processing by the management apparatus 11. The second form of the processing by the management apparatus 11 is processing in which the management apparatus 11 causes the surveillance camera 10 to capture a request image in response to, for example, an imaging request from the terminal device 100 and transmits the captured request image to the terminal device 100.

For example, it is assumed that a worker performs work at a certain disaster site and the disaster site is surveilled by the surveillance camera 10 installed on a high ground around the disaster site. The worker possesses the terminal device 100. In a case where an imaging request signal for imaging the periphery where the worker at the disaster site is present is transmitted from the terminal device 100 of the worker to the management apparatus 11, the management apparatus 11 executes the processing of the second form shown in FIG. 18. The management apparatus 11 stores the correspondence information in which the coordinates of the wide area image of the surveillance camera 10 that surveils the disaster site, the control parameter of the revolution mechanism 16, and the longitude and latitude are associated with each other, as in the case of the wide area image 90 of the construction site described in FIG. 7.

The management apparatus 11 determines whether or not the position information indicating the imaging location has been received from the terminal device 100 (step S41).

In step S41, in a case where the position information has not been received from the terminal device 100 (step S41: No), the management apparatus 11 waits until the position information is received. In step S41, in a case where the position information has been received from the terminal device 100 (step S41: Yes), the management apparatus 11 acquires the revolution control value of the revolution mechanism 16 for imaging the location for which the imaging request is made, based on the received position information and the correspondence information (step S42). The revolution control value of the revolution mechanism 16 is a pan/tilt value for imaging the location for which the imaging request is made.

Next, the management apparatus 11 transmits a revolution instruction signal for controlling the revolution of the revolution mechanism 16 to the revolution mechanism 16, based on the revolution control value acquired in step S42, to cause the revolution mechanism 16 to revolve (step S43).

Next, the management apparatus 11 transmits an imaging instruction signal for controlling the imaging of the surveillance camera 10 to the surveillance camera 10 to capture the image (step S44).

Next, the management apparatus 11 receives the captured image data (first captured image data) captured by the surveillance camera 10 from the surveillance camera 10 (step S45).

Next, the management apparatus 11 transmits the first captured image data of the surveillance camera 10 received in step S45 to the terminal device 100 of the worker who has made the imaging request (step S46). In this case, the management apparatus 11 may display, on the display 13a, the first captured image represented by the first captured image data received from the surveillance camera 10.

As described above, according to the second form of the processing by the management apparatus 11, it is possible to capture information that is difficult for the worker who works at the disaster site to know, for example, an image for knowing a situation of the periphery where the worker is present, by the surveillance camera 10 installed at a place where the disaster site is viewed, and to transmit the captured image to the terminal device 100 of the worker. Accordingly, the images captured by the surveillance camera 10 and the terminal device 100, which are different in the distance to the imaging target, can be mutually utilized.

In the above-described example, a case where the terminal device 100 of the worker makes the imaging request for the management apparatus 11 to perform imaging of the periphery where the worker is present at the disaster site has been described, but the present disclosure is not limited thereto. For example, the worker may designate a position at which imaging is desired, and the image around the designated position may be captured by the surveillance camera 10.

### <Second Form of Processing by Imaging System 1>

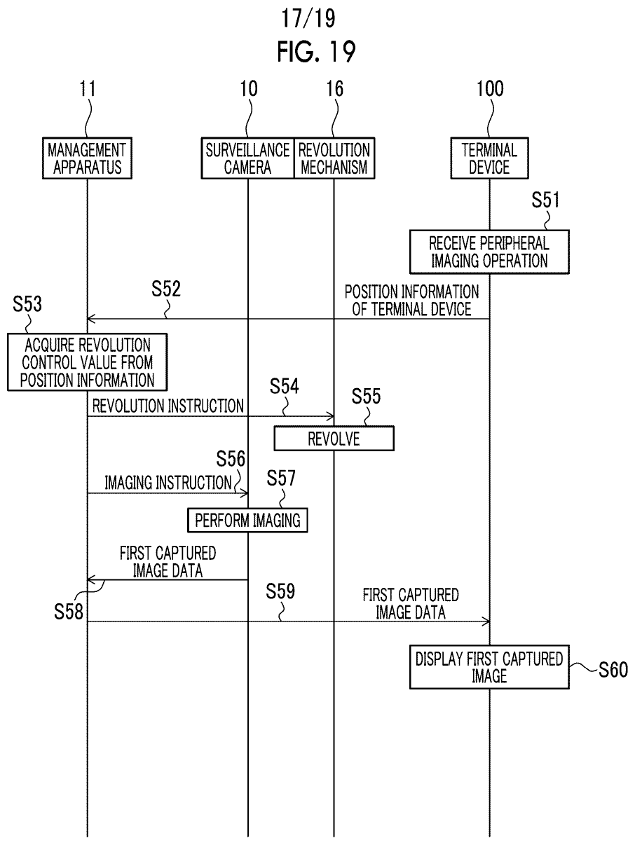

FIG. 19 is a sequence diagram showing an example of the second form of processing by the imaging system 1. The second form of the processing by the imaging system 1 is, for example, processing in which the terminal device 100 requests the management apparatus 11 to capture an image at a predetermined position, the management apparatus 11 causes the surveillance camera 10 to capture the image in response to the request, and the captured image is transmitted to the terminal device 100.

For example, in a certain disaster site, the surveillance camera 10 is installed on a high ground around the disaster site. The state of the disaster site is imaged by the surveillance camera 10. At the disaster site, a worker is performing work. The worker possesses the terminal device 100. A user (surveillant) is present in the management room in which the management apparatus 11 is installed, and surveils the situation of the disaster site.

First, the terminal device 100 receives a peripheral imaging operation from the worker who possesses the terminal device 100 (step S51). The peripheral imaging operation is an operation of starting an imaging request for the management apparatus 11 to capture an image of the periphery (the periphery of the terminal device 100) where the worker is present. For example, the peripheral imaging operation is an operation of touching an imaging request start button on the menu screen displayed on the screen of the terminal device 100. In a case where the peripheral imaging operation has been received in step S51, the terminal device 100 transmits the position information (GPS information) of the terminal device 100 to the management apparatus 11 (step S52).

Next, the management apparatus 11 receives the position information of the terminal device 100 transmitted in step S52, and acquires the revolution control value of the revolution mechanism 16 from the received position information (step S53). For example, the management apparatus 11 acquires the revolution control value (pan/tilt value) of the revolution mechanism 16 for imaging the location for which the imaging request is made, based on the received position information and the correspondence information. Next, the management apparatus 11 transmits a revolution instruction signal for controlling the revolution of the revolution mechanism 16 to the revolution mechanism 16, based on the revolution control value acquired in step S53 (step S54).

Next, the revolution mechanism 16 receives the revolution instruction signal transmitted in step S54 and performs the revolution operation in accordance with the received revolution instruction signal (step S55).

Next, in a case where the revolution operation of the revolution mechanism 16 in step S55 is ended, the management apparatus 11 transmits an imaging instruction signal for controlling the imaging of the surveillance camera 10 to the surveillance camera 10 (step S56). For example, the management apparatus 11 may calculate a focus value with respect to the imaging position, and include the calculated focus value information in the imaging instruction signal and transmit the imaging instruction signal.

Next, the surveillance camera 10 receives the imaging instruction signal transmitted in step S56 and performs the imaging in accordance with the received imaging instruction signal (step S57). Next, the surveillance camera 10 transmits the image captured in step S57, that is, the image data (first captured image data) of the image of the periphery (the periphery of the terminal device 100) where the worker is present, to the management apparatus 11 (step S58).

Next, the management apparatus 11 receives the first captured image data transmitted in step S58 and transmits the first captured image data to the terminal device 100 of the worker who has made the imaging request (step S59).

Next, the terminal device 100 receives the first captured image data transmitted from the management apparatus 11 in step S59, and displays the first captured image on the screen of the terminal device 100 (step S60).

As described above, according to the second form of the processing by the imaging system 1, it is possible to request the management apparatus 11 for information that is difficult for the worker at the disaster site to know, for example, an image for knowing a situation of the periphery where the worker is present, to capture an image of the periphery of the worker in response to the request by the surveillance camera 10 installed at a place where the disaster site is viewed, and to transmit the captured image to the terminal device 100 of the worker. Accordingly, the images captured by the surveillance camera 10 and the terminal device 100, which are different in the distance to the imaging target, can be mutually utilized. The worker at the disaster site can accurately check the situation around the site, and it is possible to improve workability and ensure safety.

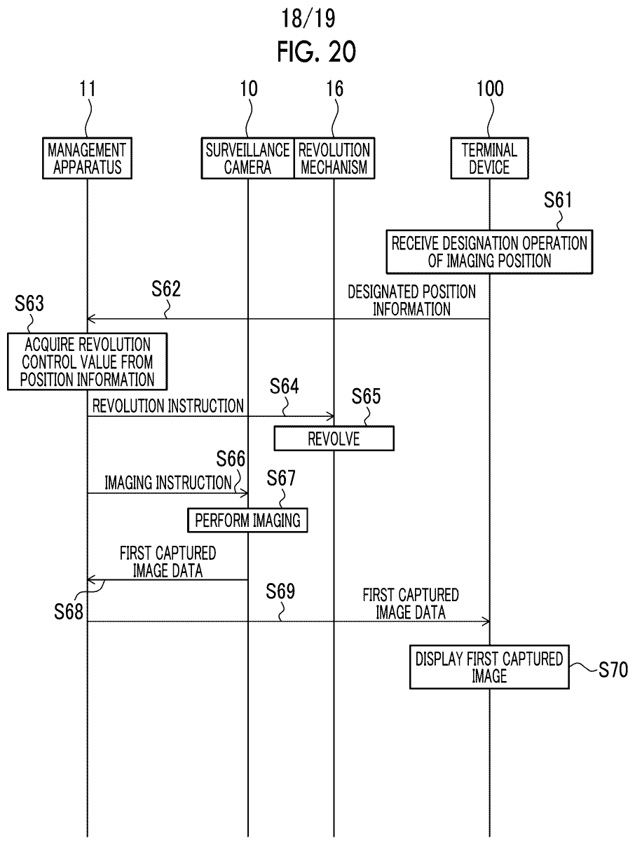

FIG. 20 is a sequence diagram showing another example in the second form of the processing by the imaging system 1. In the example shown in FIG. 20, first, the terminal device 100 receives a designation operation of the imaging position from the worker who possesses the terminal device 100 (step S61). The designation operation of the imaging position is an operation of starting an imaging request for the management apparatus 11 to capture an image around a position designated by the worker. For example, the designation operation of the imaging position includes a touch operation of the imaging request start button on the menu screen displayed on the screen of the terminal device 100 and an operation of designating an imaging request position. The designation of the imaging request position is performed, for example, by performing a touch operation on any position on the peripheral map displayed on the screen of the terminal device 100. In a case where the designation operation of the imaging position has been received in step S61, the terminal device 100 transmits the position information (longitude and latitude) of the designated position to the management apparatus 11 (step S62).

Next, the management apparatus 11 receives the position information of the designated position transmitted in step S62, and acquires the revolution control value of the revolution mechanism 16 from the received position information (step S63). A method of acquiring the revolution control value is the same as the method of acquiring the revolution control value in step S53 in FIG. 19.

In addition, since the processing of the next steps S64 to S67 is the same as the processing of steps S54 to S57 in FIG. 19, the description thereof will be omitted.

Next, the surveillance camera 10 transmits the image captured in step S67, that is, the image data (first captured image data) of the image around the position designated by the worker, to the management apparatus 11 (step S68).

In addition, since the processing of the next steps S69 and S70 is the same as the processing of steps S59 and S60 in FIG. 19, the description thereof will be omitted.

As described above, according to the other example of the second form, it is possible to request the management apparatus 11 to capture an image of the position designated by the worker at the disaster site, to capture an image corresponding to the request by the surveillance camera 10, and to transmit the captured image to the terminal device 100 of the worker. Accordingly, the images captured by the surveillance camera 10 and the terminal device 100, which are different in the distance to the imaging target, can be mutually utilized. The worker at the disaster site can accurately check the situation of the disaster.

### <Storage Medium of Management Program>

In each of the management controls described above, the example has been described in which the management program of each embodiment is stored in the storage 60B of the management apparatus 11 and the CPU 60A of the management apparatus 11 executes the management program in the memory 60C, but the technique of the present disclosure is not limited to this.

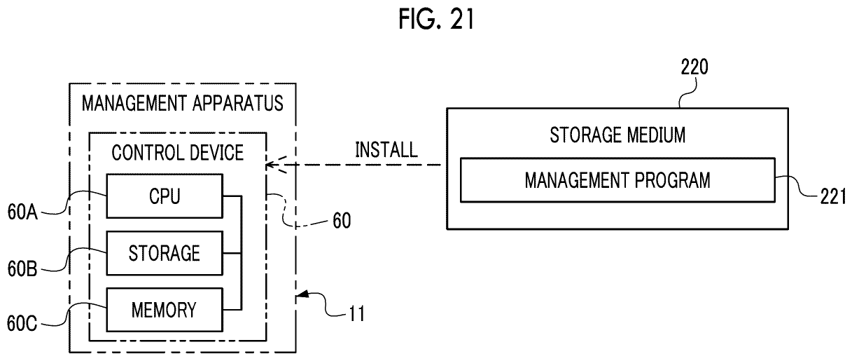

FIG. 21 is a diagram showing an example of an aspect in which a management program for management control is installed in the control device 60 of the management apparatus 11 from a storage medium in which the management program is stored. As shown in FIG. 21 as an example, a management program 221 may be stored in a storage medium 220 which is a non-temporary storage medium. In a case of the example shown in FIG. 21, the management program 221 stored in the storage medium 220 is installed in the control device 60, and the CPU 60A executes each of the above-described processing according to the management program 221.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-153055) filed on Sep. 26, 2022, the content of which is incorporated in the present application by reference.

### EXPLANATION OF REFERENCES

1: imaging system

10, 10a: surveillance camera

11: management apparatus

12: communication line

13a, 43B: display

13b: keyboard

13c: mouse

14: secondary storage device

15: optical system

15B: lens group

15B1: anti-vibration lens

15B2: zoom lens

16: revolution mechanism

17, 21: lens actuator

19: computer

22, 23, 75, 76: driver

22: BIS driver

23: OIS driver

25: imaging element

25A: light-receiving surface

27: imaging element actuator

28: lens driver

29, 45: correction mechanism

31: DSP

32: image memory

33: correction unit

34, 34a, 66 to 69, 79, 80, 103: communication I/F

35, 60C, 102: memory

36, 60B: storage

37, 60A: CPU

38, 70, 109: bus

39, 47: position sensor

40: shake amount detection sensor

43: UI system device

43A, 62: reception device

60: control device

71: yaw-axis revolution mechanism

72: pitch-axis revolution mechanism

73, 74: motor

90: wide area image

90a: region designation cursor

91: detailed image

100: terminal device

101: processor

104: GNSS unit

105: user I/F

106: imaging unit

111, 112: captured image

220: storage medium

221: management program

e1: partial region

W1: worker

V1: dump truck

E1: surveillance target region

What is claimed is:

1. A management apparatus that is communicable with a first imaging apparatus that images a subject and a second imaging apparatus that is in a region which the first imaging apparatus is capable of imaging, the management apparatus comprising:
a processor, wherein
the processor is configured to acquire identification information of the second imaging apparatus based on at least one of: a result of image processing on first imaging data acquired by the first imaging apparatus; or information related to imaging of the first imaging apparatus.

2. The management apparatus according to claim 1, wherein
the processor is configured to transmit, to the second imaging apparatus, imaging instruction information indicating an imaging condition of the subject, based on the identification information.

3. The management apparatus according to claim 2, wherein
the imaging condition is designated by a user of the management apparatus.

4. The management apparatus according to claim 2, wherein
the imaging condition is a condition for supplementing a shortage of the first imaging data.

5. The management apparatus according to claim 4, wherein
the imaging condition is indicated by a fixed tool.

6. The management apparatus according to claim 2, wherein
the processor is configured to cause a display device to output at least one of: a first captured image represented by the first imaging data; or a second captured image represented by second imaging data acquired by the second imaging apparatus, and receive designation of the imaging condition from a user.

7. The management apparatus according to claim 1, wherein
the information related to the imaging is a range set based on an imaging direction of the first imaging apparatus.

8. The management apparatus according to claim 7, wherein
the range is set based on an angle of view of the first imaging apparatus.

9. The management apparatus according to claim 7, wherein
the range is set based on position information associated with the imaging direction.

10. The management apparatus according to claim 7, wherein
the processor is configured to acquire the identification information based on the range and GPS information of a plurality of imaging apparatuses including the second imaging apparatus.

11. The management apparatus according to claim 1, wherein
the processor is configured to acquire the identification information of the second imaging apparatus based on a recognition result, by the image processing, of a possessor of the second imaging apparatus or of an installation target of the second imaging apparatus.

12. A management apparatus that is communicable with a first imaging apparatus that images a subject and a second imaging apparatus that is at a different location from a location at which the first imaging apparatus is provided, the management apparatus comprising:
a processor, wherein
the processor is configured to:
cause the first imaging apparatus to perform imaging based on at least one of:
position information of the second imaging apparatus; or an imaging condition designated from the second imaging apparatus; and
transmit first imaging data acquired by the first imaging apparatus to the second imaging apparatus.

13. The management apparatus according to claim 12, wherein
the processor is configured to cause a display device to output at least one of: a first captured image represented by the first imaging data acquired by the first imaging apparatus; or a second captured image represented by second imaging data acquired by the second imaging apparatus.

14. The management apparatus according to claim 1, wherein
the management apparatus is communicable with a revolution apparatus that causes the first imaging apparatus to revolve, and
the processor is configured to acquire correspondence information between a control value of the revolution apparatus and a position of an imaging target by the first imaging apparatus.

15. The management apparatus according to claim 14, wherein
the processor is configured to:
generate first composite image data by combining a plurality of pieces of image data acquired by the first imaging apparatus while changing an imaging direction of the first imaging apparatus by controlling the revolution apparatus; and
generate correspondence information between coordinates of a first composite image represented by the first composite image data and the control value of the revolution apparatus.

16. An imaging system comprising:
a first imaging apparatus that images a subject;
a second imaging apparatus that is in a region which the first imaging apparatus is capable of imaging; and
a management apparatus that is communicable with the first imaging apparatus and the second imaging apparatus, wherein
a processor of the management apparatus is configured to acquire identification information of the second imaging apparatus based on at least one of: a result of image processing on first imaging data acquired by the first imaging apparatus; or information related to imaging of the first imaging apparatus.

17. An imaging system comprising:
a first imaging apparatus that images a subject;
a second imaging apparatus that is at a different location from a location at which the first imaging apparatus is provided; and
a management apparatus that is communicable with the first imaging apparatus and the second imaging apparatus, wherein
a processor of the management apparatus is configured to:
cause the first imaging apparatus to perform imaging based on at least one of:
position information of the second imaging apparatus; or an imaging condition designated from the second imaging apparatus; and
transmit first imaging data acquired by the first imaging apparatus to the second imaging apparatus.

18. A management method by a management apparatus that is communicable with a first imaging apparatus that images a subject and a second imaging apparatus that is in a region which the first imaging apparatus is capable of imaging, the method comprising:
via a processor of the management apparatus,
acquiring identification information of the second imaging apparatus based on at least one of: a result of image processing on first imaging data acquired by the first imaging apparatus; or information related to imaging of the first imaging apparatus.

19. A management method by a management apparatus that is communicable with a first imaging apparatus that images a subject and a second imaging apparatus that is at a different location from a location at which the first imaging apparatus is provided, the method comprising:
via a processor of the management apparatus,
causing the first imaging apparatus to perform imaging based on at least one of:
position information of the second imaging apparatus; or an imaging condition designated from the second imaging apparatus; and
transmitting first imaging data acquired by the first imaging apparatus to the second imaging apparatus.

20. A non-transitory computer readable medium storing a management program of a management apparatus that is communicable with a first imaging apparatus that images a subject and a second imaging apparatus that is in a region which the first imaging apparatus is capable of imaging, the program causing a processor of the management apparatus to execute a process comprising:
acquiring identification information of the second imaging apparatus based on at least one of: a result of image processing on first imaging data acquired by the first imaging apparatus; or information related to imaging of the first imaging apparatus.

21. A non-transitory computer readable medium storing a management program of a management apparatus that is communicable with a first imaging apparatus that images a subject and a second imaging apparatus that is at a different location from a location at which the first imaging apparatus is provided, the program causing a processor of the management apparatus to execute a process comprising:
causing the first imaging apparatus to perform imaging based on at least one of: position information of the second imaging apparatus; or an imaging condition designated from the second imaging apparatus; and
transmitting first imaging data acquired by the first imaging apparatus to the second imaging apparatus.
